(19) United States
(12) Patent Application Publication
(10) Pub. No.: US 2026/0043363 A1
(43) Pub. Date: Feb. 12, 2026

(54) SYSTEMS AND METHODS FOR CONTROLLING AN ENGINE SPEED OR A MOTOR SPEED OF AN ENGINE OR A MOTOR PROVIDING POWER FOR A GENERATOR IN A HYDRAULICALLY POWERED POWER SYSTEM

(71) Applicant: Illinois Tool Works Inc., Glenview, IL (US)

(72) Inventor: Nathan Joe Jochman, Appleton, WI (US)

(21) Appl. No.: 19/278,083

(22) Filed: Jul. 23, 2025

Related U.S. Application Data
(60) Provisional application No. 63/682,235, filed on Aug. 12, 2024.

(51) Int. Cl. F02D 29/06; F02D 29/04; F02D 31/00; F16H 61/47; F16H 61/475

(52) U.S. Cl. CPC F02D 29/06; F02D 29/04; F02D 31/001; F16H 61/47; F16H 61/475; F02D 2200/50

(57) ABSTRACT

A hydraulically powered power system comprises: a hydraulic motor configured to convert an input hydraulic flow to motor power; a generator drivingly coupled to the hydraulic motor and configured to convert the motor power to an electrical output; a first sensor configured to measure a first operating characteristic of the generator and to generate a first feedback signal comprising a first measured operating characteristic associated with the first operating characteristic; and control circuitry configured to: monitor the first feedback signal to determine a first operating characteristic difference based on a first target operating characteristic and the first measured operating characteristic, and upon determining the first operating characteristic difference, output a control signal to control an engine to modify an engine speed of the engine based on the first operating characteristic difference.

### RELATED APPLICATIONS

The present application claims the benefit of U.S. Provisional Patent Application Ser. No. 63/682,235, filed Aug. 12, 2024, entitled “SYSTEMS AND METHODS FOR CONTROLLING AN ENGINE SPEED OR A MOTOR SPEED OF AN ENGINE OR A MOTOR PROVIDING POWER FOR A GENERATOR IN A HYDRAULICALLY POWERED POWER SYSTEM.” The entirety of U.S. Provisional Patent Application Ser. No. 63/682,235 is expressly incorporated herein by reference.

### FIELD OF THE DISCLOSURE

This disclosure relates generally to generators powered by engines and/or motors and, more particularly, to hydraulically powered power systems comprising generators drivingly coupled to hydraulic motors.

### BACKGROUND

Hydraulically powered power systems use hydraulic fluid to generate power. For example, a hydraulically powered power system may include a pump which pumps hydraulic fluid through a hydraulic circuit comprising a hydraulically powered device. For example, the pump may power a hydraulically driven motor, thereby actuating the motor to generate and output mechanical power, e.g., to power a generator.

### SUMMARY

Hydraulically powered power systems having a generator drivingly coupled to a hydraulic motor and methods for controlling hydraulically powered power systems are disclosed, substantially as illustrated by and described in connection with at least one of the figures, as set forth more completely in the claims.

### BRIEF DESCRIPTION OF THE DRAWINGS

FIG. 1 illustrates a block diagram of a hydraulically powered power system, in accordance with aspects of this disclosure;

FIG. 2 illustrates an example control circuitry of a hydraulically powered power system, in accordance with aspects of this disclosure;

FIG. 3 illustrates a flowchart representative of a first exemplary process for controlling a hydraulically powered power system and/or components thereof, in accordance with aspects of this disclosure; and

FIG. 4. illustrates an example of a second flowchart representative of example machine readable instructions which may be executed by control circuitry to control a hydraulically powered power system and/or components thereof, in accordance with aspects of this disclosure

The figures are not necessarily to scale. Where appropriate, similar or identical reference numbers are used to refer to similar or identical components.

### DETAILED DESCRIPTION

Some disclosed example hydraulically powered power systems and methods involve adjusting an engine speed of an engine based on a measured operating characteristic of a generator and a target operating characteristic of a generator. Some disclosed example hydraulically powered power systems and methods involve adjusting a motor speed of a motor based on a measured operating characteristic of a generator and a target operating characteristic of a generator.

A disclosed example hydraulically powered power system includes a generator, which is used to generate an electrical output (e.g., alternating current (“AC”) power and/or direct current (“DC”) power). The generator generates the electrical output by being drivingly coupled to a mechanical power source such that the generator receives a mechanical power (e.g., a rotational power) from the power source. Accordingly, in some disclosed examples, the generator is drivingly coupled to a hydraulic motor (e.g., via one or more drive shafts). The hydraulic motor generates a motor power (e.g., a rotational power), and the generator receives the motor power and converts the motor power to the electrical output. The hydraulic motor may receive input hydraulic flow of a hydraulic fluid from a hydraulic pump, which pumps the hydraulic fluid through a hydraulic circuit comprising the hydraulic pump and the hydraulic motor. Accordingly, the amount of motor power generated by the hydraulic motor (e.g., as measured in rotations per minute (“RPM”) of a drive shaft) may depend on a flow rate of the hydraulic fluid (e.g., measured in cubic meters per second (“cms”), cubic feet per second (“cfs”), gallons per minute (“gpm”), etc.) pumped by the hydraulic pump. The hydraulic pump generates the input hydraulic flow of the hydraulic fluid by receiving an input power (e.g., a mechanical power) and converting the input power into the input hydraulic flow. Accordingly, the hydraulic pump may be coupled to a power source, to provide the input power to the hydraulic pump.

In some disclosed examples, the power source may be an engine (e.g., an engine of a vehicle, a combustion engine, etc.) drivingly coupled to the hydraulic pump (e.g., via one or more drive shafts), and the hydraulic pump receives input power (e.g., a rotational power generated via rotating one or more drive shafts) from the engine and converts the input power to the input hydraulic flow. Accordingly, in some disclosed example hydraulically powered power systems, input power is generated by an engine, a hydraulic pump receives the input power and converts the input power to an input hydraulic flow, a hydraulic motor receives the input hydraulic flow and converts the input hydraulic flow to a motor power, and a generator receives the motor power and converts the motor power to an electrical output.

In some disclosed examples, the power source may be an electric motor (e.g., an electric motor of a vehicle, etc.) drivingly coupled to the hydraulic pump (e.g., via one or more drive shafts), and the hydraulic pump receives input power (e.g., a rotational power generated via rotating one or more drive shafts) from the electric motor and converts the input power to the input hydraulic flow. Accordingly, in some disclosed example hydraulically powered power systems, input power is generated by an electric motor, a hydraulic pump receives the input power and converts the input power to an input hydraulic flow, a hydraulic motor receives the input hydraulic flow and converts the input hydraulic flow to a motor power, and a generator receives the motor power and converts the motor power to an electrical output.

However, in some such examples, characteristics of the input power (e.g., an RPM of a drive shaft rotated by the engine and/or by the electric motor) may not be directly tied to and/or linearly correlated with characteristics of the motor power (e.g., an RPM of a drive shaft rotated by the hydraulic motor), e.g., due to variables introduced by the intervening conversions of the input power to input hydraulic flow and of the input hydraulic flow to the motor power. For example, variables introduced by fluid mechanics of the hydraulic fluid provided to the hydraulic motor as input hydraulic flow can cause unwanted variances in characteristics (e.g., an RPM) of the motor power generated by the motor power that are not directly determined by variances in characteristics (e.g., an RPM) of the input power.

Accordingly, some disclosed examples measure an operating characteristic of a generator and compare the measured operating characteristic to a target operating characteristic (i.e., a desired operating characteristic) and control an engine to increase or decrease an engine speed of the engine (e.g., an RPM of a drive shaft rotated by the engine) to bring the operating characteristic closer to the target operating characteristic and/or maintain an equivalence and/or substantial equivalence between the operating characteristic and the target operating characteristic. An operating characteristic may comprise, e.g., one or more of a voltage of an electrical output of the generator, a frequency of the electrical output, a current of the electrical output, an operating speed of the generator (e.g., an RPM of the generator), and/or an operating mode of the generator (e.g., an idle mode, a synchronized speed mode, a variable speed mode, a fixed speed mode, etc.).

Some disclosed examples control measure an operating characteristic of a generator and compare the measured operating characteristic to a target operating characteristic and control a motor (e.g., an electric motor) to increase or decrease a motor speed of the motor (e.g., an RPM of a drive shaft rotated by the motor) to bring the operating characteristic closer to the target operating characteristic and/or maintain an equivalence and/or substantial equivalence between the operating characteristic and the target operating characteristic.

Some disclosed examples control measure an operating characteristic of a generator and compare the measured operating characteristic to a target operating characteristic and control a power source (e.g., a device rotating a drive shaft) to increase or decrease a characteristic of an input power generated by the power source (e.g., an RPM of a drive shaft rotated by the power source) to bring the operating characteristic closer to the target operating characteristic and/or maintain an equivalence and/or substantial equivalence between the operating characteristic and the target operating characteristic.

As an example, upon measuring a voltage of the electrical output (i.e., an operating characteristic) as 25 volts (“V”) while targeting a target value of 24 V (i.e., a target operating characteristic), some disclosed examples may, based on the difference of 2 V, control an engine to reduce an engine speed of the engine to reduce the voltage of the electrical output. As another example, upon measuring a frequency of the electrical output (i.e., an operating characteristic) as 67 hertz (“Hz”) while targeting a target range of 50-60 Hz (i.e., a target operating characteristic), some disclosed examples may, based on the difference of 7 Hz from the upper bound of the target range of 60 Hz, control an electric motor to reduce a motor speed of the electric motor to reduce the frequency of the electrical output. In some examples, an engine and/or a motor may be controlled to make very minor and/or incremental changes to an engine speed of the engine and/or a motor speed of the motor, such as changes of only 1 RPM. In some examples, a plurality of operating characteristics may be measured and/or a plurality of target operating characteristics may be compared to one or more measured operating characteristics. By continuously monitoring one or more operating characteristics of a generator driven by a hydraulic motor's motor power, comparing the one or more monitored operating characteristics to one or more target operating characteristics, and modifying an engine speed of an engine and/or a motor speed of an electric motor based on differences between the one or more monitored operating characteristics and the one or more target operating characteristics, disclosed examples may reduce variation in the one or more monitored operating characteristics caused by variances in the motor power.

As used herein, the term “electric motor” includes any device capable of converting electrical power (e.g., AC power and/or DC power) into linear or rotary motion.

As used herein, the term “hydraulic motor” includes any device capable of converting fluid pressure into linear or rotary motion. Example hydraulic motors operate by pressurizing fluid from a hydraulic pump into a rotary motion as a motor output shaft is driven by the pressurized fluid acting on one or more components of the hydraulic motor (e.g., gears, pistons, etc.).

As used herein, the term “hydraulic power system” includes a system having a motor, a fluid reservoir, and a pump. The hydraulic power system applies hydraulic pressure to one or more devices to drive motors, shafts, cylinders, and/or other parts of the hydraulic power system.

As used herein, the term “hydraulic pump” describes a device to convert mechanical power into hydraulic energy, thereby serving as a source for mechanical power output, such as to a hydraulic motor.

As used herein, the term “welding-type power” refers to power suitable for welding, plasma cutting, induction heating, air carbon arc cutting (“CAC-A”) and/or hot wire welding/preheating (including laser welding and laser cladding). As used herein, the term “welding-type power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, the term “output equipment” refers to one or more devices that receive power (e.g., input power, input hydraulic flow, motor power, an electrical output, welding-type power, etc.) from one or more systems (e.g., a hydraulically powered power system, a hydraulic circuit, etc.), devices (e.g., a power source, a hydraulic pump, a hydraulic motor, a generator, power conversion circuitry), and/or components. For example, output equipment may include one or more hydraulic pumps, one or more hydraulic motors, one or more generators, one or more power conversion circuitries, one or more devices (e.g., any, some, or all of the auxiliary devices described elsewhere herein), and/or one or more tools (e.g., any, some, or all of the tools described elsewhere herein).

As used herein, the term “processor” means processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general-purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processor may be coupled to, and/or integrated with a memory storage device.

As utilized herein the terms “circuits,” “circuitry,” “controller,” and “control circuitry” refer to physical electronic components (i.e., hardware) and any software and/or firmware (“code”) which may configure the hardware, be executed by the hardware, and/or otherwise be associated with the hardware. As used herein, for example, a “circuit” may comprise any analog and/or digital components, power and/or control elements (such as a microprocessor, digital signal processor (DSP), software, and the like), discrete and/or integrated components, associated software, hardware, and/or firmware, and/or portions and/or combinations thereof. As used herein, for example, a particular processor and memory storage device may comprise a first “circuit” when executing a first set of one or more lines of code and may comprise a second “circuit” when executing a second set of one or more lines of code. As utilized herein, circuitry is “operable” to, “configurable to,” and/or “configured to” perform a function whenever the circuitry comprises the necessary hardware and code (if any is necessary) to perform the function, regardless of whether performance of the function is disabled or not enabled (for example, by an operator-configurable setting, factory trim, etc.).

As used herein, the term “communications circuitry” refers to physical electronic components (i.e., hardware) and, in some examples, any software and/or firmware (i.e., code) which may configure the hardware, be executed by the hardware, and/or otherwise enable the hardware to communicate with one or more other devices (e.g., with communications circuitry of such one or more other devices). Communications circuitry may include hardware capable of wired and/or wireless communication with one or more other devices. Hardware capable of wired communication may include, e.g., one or more cables or other optical communication mechanisms, one or more computer buses, and/or one or more additional wired mechanisms for communicating with one or more communications networks and/or one or more devices. Hardware capable of wireless communications may include, e.g., one or more transceivers, one or more antennas, one or more modems, one or more local area network (“LAN”) ports, one or more wireless fidelity (“Wi-Fi”) cards, one or more WiMax cards, mobile communications hardware, near-field communication hardware, satellite communication hardware, hardware configured to communicate in accordance with one or more wireless communication protocols (e.g., IrDA, Bluetooth, Wireless USB, Z-Wave, ZigBee, radio frequency identification (“RFID”), one or more other near field communications (“NFC”) protocols, and/or one or more other protocols for close-proximity and/or wireless communication), and/or other hardware for wirelessly communicating with one or more communications networks and/or one or more devices. Communications circuitry may include one or more network interfaces, one or more input-output (“I/O”) interfaces, and/or one or more other interfaces for communicating data (e.g., directly, via one or more communications paths, etc.) to and/or from one or more communications networks. An example network interface may include hardware, firmware, and/or software to communicatively couple communications circuitry to one or more communications networks. A network interface may include and/or be coupled to one or more communication paths. A communication path includes hardware which provides signal interconnectivity between one or more components (e.g., control circuitry and a transceiver). A network interface may include any hardware for transmitting and/or receiving communications (e.g., IEEE 802.X-compliant wireless and/or wired communications hardware). An example I/O interface includes hardware, firmware, and/or software to connect one or more I/O devices to control circuitry (communicatively coupled to, e.g., communications circuitry comprising the I/O interface) for providing input to the control circuitry and/or providing output from the control circuitry. For example, the I/O interface may include a graphics processing unit for interfacing with a display device, a universal serial bus port for interfacing with one or more USB-compliant devices, a FireWire, a field bus, and/or any other type of interface. Example I/O device(s) may include a keyboard, a keypad, a mouse, a trackball, a pointing device, a microphone, an audio speaker, a display device, an optical media drive, a multi-touch touch screen, a gesture recognition interface, a magnetic media drive, and/or any other type of input and/or output device. Control circuitry communicatively coupled to an I/O interface may access a non-transitory machine-readable medium via the I/O interface and/or one or more I/O device(s). Examples of a machine-readable medium include optical discs (e.g., compact discs (CDs), digital versatile/video discs (DVDs), Blu-ray discs, etc.), magnetic media (e.g., floppy disks), portable storage media (e.g., portable flash drives, secure digital (SD) cards, etc.), and/or any other type of removable and/or installed machine-readable media.

A “communications network” may include one or more of the Internet, one or more personal area networks (“PAN(s)”), one or more LANs, one or more wide area networks (“WAN(s)”), one or more cellular networks, one or more satellite networks, one or more global positioning systems, one or more other such networks, and/or any combination thereof. A LAN may include, e.g., one or more wired technologies (e.g., Ethernet, USB, etc.) and/or one or more wireless technologies (e.g., Wi-Fi). A PAN may include one or more wired technologies (e.g., USB, FireWire, and/or one or more other computer buses) and/or one or more wireless technologies (e.g., Bluetooth, Wireless USB, IrDA, Z-Wave, ZigBee, RFID, one or more other NFC protocols, and/or one or more other protocols for close-proximity and/or wireless communication). A cellular network may include, e.g., technologies such as LTE, WiMAX, UMTS, CDMA, GSM, 3G, 4G, 5G, 6G, and/or one or more other technologies.

As used, herein, the term “memory,” “memory storage device,” and/or “memory device” means computer hardware or circuitry to store information for use by a processor and/or other digital device. The memory, memory storage device, and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory, memory storage device, and/or memory device can be configured to store code, instructions, applications, software, firmware, and/or data, and may be external, internal, or both with respect to a processor.

As used herein, the term “torch” or “welding-type tool” can include a hand-held or robotic welding torch, gun, or other device used to create the welding arc.

As used herein, the term “welding mode” or “welding operation” is the type and/or modality of process and/or output used by a welding system, such as constant current (“CC”) welding, constant voltage (“CV”) welding, pulse welding, metal inert gas (“MIG”) welding or gas metal arc welding (“GMAW”), tungsten inert gas (“TIG”) welding or gas tungsten arc welding (“GTAW”), flux cored arc welding (“FCAW”), plasma cutting, spray welding, short circuit transfer welding, etc.

As used herein, the term “boost converter” is a converter used in a circuit that boosts a voltage. For example, a boost converter can be a type of step-up converter, such as a DC-to-DC power converter that steps up voltage while stepping down current from its input (e.g., from an energy storage device) to its output (e.g., a load and/or attached power bus). It is a type of switched mode power supply.

As used herein, the term “buck converter” (e.g., a step-down converter) refers to a power converter which steps down voltage (e.g., while stepping up current) from its input to its output.

Features described herein make reference to the accompanying drawings in which exemplary embodiments of the disclosure are shown. Whenever appropriate, the same reference numerals are used throughout the drawings to refer to the same or like parts. However, it should be understood that the systems of this disclosure can be embodied in many different forms and should not be construed as limited to the embodiments set forth herein.

The term “power” is used throughout this specification, for convenience, to describe hydraulic, mechanical, and electrical power. However, the term “power,” as used herein, also includes related measures such as energy, current, voltage, resistance, conductance, and enthalpy. For example, controlling “power” may involve controlling voltage, current, energy, resistance, conductance, and/or enthalpy, and/or controlling based on “power” may involve controlling based on voltage, current, energy, resistance, conductance, and/or enthalpy.

It is to be understood that, as used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the word “exemplary” means “serving as an example, instance, or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the invention include the discussed feature, advantage, or mode of operation.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.” and “for example” set off lists of one or more non-limiting examples, instances, or illustrations. While various features, elements or steps of particular embodiments can be disclosed using the transitional phrase “comprising,” it is to be understood that alternative embodiments, including those that can be described using the transitional phrases “consisting of” or “consisting essentially of,” are implied. Thus, for example, implied alternative embodiments to an apparatus that comprises A+B+C include embodiments where an apparatus consists of A+B+C and embodiments where an apparatus consists essentially of A+B+C.

Disclosed example hydraulically powered power systems comprise: a hydraulic motor configured to convert an input hydraulic flow to motor power; a generator drivingly coupled to the hydraulic motor and configured to convert the motor power to an electrical output; a first sensor configured to measure a first operating characteristic of the generator and to generate a first feedback signal comprising a first measured operating characteristic associated with the first operating characteristic; and control circuitry configured to: monitor the first feedback signal to determine a first operating characteristic difference based on a first target operating characteristic and the first measured operating characteristic, and upon determining the first operating characteristic difference, output a control signal to control an engine to modify an engine speed of the engine based on the first operating characteristic difference.

In some example hydraulically powered power systems, the first operating characteristic comprises at least one of: a voltage of the electrical output; a frequency of the electrical output; or a current of the electrical output.

In some example hydraulically powered power systems, the first operating characteristic comprises an operating speed of the generator.

In some example hydraulically powered power systems, the first operating characteristic comprises an operating mode of the generator.

In some example hydraulically powered power systems, the first target operating characteristic comprises at least one of: a target voltage of the electrical output; a target frequency of the electrical output; or a target current of the electrical output.

In some example hydraulically powered power systems, the first target operating characteristic comprises a target operating speed of the generator.

In some example hydraulically powered power systems, the first target operating characteristic comprises a target operating mode of the generator. In some such example hydraulically powered power systems, the control circuitry is further configured to, upon determining that the target operating mode comprises a standby mode indication and that the first operating characteristic difference comprises a difference in operating mode, output the control signal to control the engine to operate at a standby speed.

In some example hydraulically powered power systems, the first target operating characteristic comprises a target operating mode of the generator and the control circuitry is further configured to, upon determining that the target operating mode comprises a synchronized speed mode indication and that the first operating characteristic difference comprises a difference in operating mode of the generator, output the control signal to control the engine to operate at a synchronized engine speed based on a target value of the first target operating characteristic.

In some example hydraulically powered power systems, the first target operating characteristic comprises a target operating mode of the generator and the control circuitry is further configured to, upon determining that the target operating mode comprises a variable mode indication and that the first operating characteristic difference comprises a difference in operating mode of the generator, output the control signal to control the engine to operate at a variable engine speed based on a variable target value of the first target operating characteristic.

In some example hydraulically powered power systems, the first target operating characteristic comprises a target operating mode of the generator and the control circuitry is further configured to, upon determining that the target operating mode comprises a fixed speed mode indication and that the first operating characteristic difference comprises a difference in operating mode of the generator, output the control signal to control the engine to operate at a fixed engine speed based on a target value of the first target operating characteristic.

In some example hydraulically powered power systems, the first target operating characteristic comprises a target value; and the control circuitry is further configured to determine the first operating characteristic difference by determining a difference between a magnitude of the first measured operating characteristic and the target value.

In some example hydraulically powered power systems, the first target operating characteristic comprises a target threshold value; and the control circuitry is further configured to determine the first operating characteristic by determining that a magnitude of the first measured operating characteristic is higher than or lower than the target threshold value.

In some example hydraulically powered power systems, the first target operating characteristic comprises a target value range; and the control circuitry is further configured to determine the first operating characteristic difference by determining that a magnitude of the first measured operating characteristic is outside of the target value range.

In some example hydraulically powered power systems, the hydraulically powered power system further comprises a user interface configured to generate a user interface signal, wherein the control circuitry is further configured to determine the first target operating characteristic based on the user interface signal.

In some example hydraulically powered power systems, the hydraulically powered power system further comprises output equipment configured to receive the electrical output from the generator and generate an output equipment signal, wherein the control circuitry is further configured to determine the first target operating characteristic based on the output equipment signal.

In some example hydraulically powered power systems, the hydraulically powered power system further comprises a second sensor configured to generate a second feedback signal, wherein the control circuitry is further configured to determine the first target operating characteristic based on the second feedback signal.

In some example hydraulically powered power systems, the first target operating characteristic comprises at least one of a predetermined target value, one or more predetermined target threshold values, or a predetermined target value range.

In some example hydraulically powered power systems, the hydraulically powered power system further comprises a hydraulic pump configured to receive input power from the engine and to convert the input power to the input hydraulic flow, wherein the hydraulic motor is hydraulically coupled to the hydraulic motor.

In some example hydraulically powered power systems, the hydraulically powered power system further comprises output equipment configured to receive the electrical output from the generator; and a second sensor configured to measure a load of the output equipment and to generate a second feedback signal comprising a measured load associated with the load, wherein the control circuitry is further configured to: monitor the second feedback signal to determine a load difference based on a target load and the measured load, and upon determining the load difference, output the control signal to control the engine to modify the engine speed based on the load difference.

In some example hydraulically powered power systems, the hydraulically powered power system further comprises a second sensor configured to measure a second operating characteristic of the generator and to generate a second feedback signal comprising a second measured operating characteristic associated with the second operating characteristic, wherein the control circuitry is further configured to: monitor the second feedback signal to determine a second operating characteristic difference based on a second target operating characteristic and the second measured operating characteristic; and upon determining the second operating characteristic difference, output the control signal to control the engine to modify the engine speed based on the second operating characteristic difference.

In some example hydraulically powered power systems, the control circuitry is further configured to: determine a second target operating characteristic different from the first target operating characteristic; monitor the first feedback signal to determine a second operating characteristic difference based on the second target operating characteristic and the first measured operating characteristic; and upon determining the second operating characteristic difference, output the control signal to control the engine to modify the engine speed based on the second operating characteristic difference.

In some example hydraulically powered power systems, the hydraulically powered power system further comprises a vehicle comprising the engine.

Disclosed example hydraulically powered power systems comprise: a hydraulic motor configured to convert an input hydraulic flow to motor power; a generator drivingly coupled to the hydraulic motor and configured to convert the motor power to an electrical output; output equipment configured to receive the electrical output from the generator; a first sensor configured to measure a first load of the output equipment and to generate a first feedback signal comprising a first measured load associated with the first load; and control circuitry configured to: monitor the first feedback signal to determine a first load difference based on a first target load and the first measured load; and upon determining the first load difference, output a control signal to control an engine to modify an engine speed of the engine based on the first load difference.

In some example hydraulically powered power systems, the first target load comprises a target value; and the control circuitry is further configured to determine the first load difference by determining a difference between a magnitude of the first measured load and the target value.

In some example hydraulically powered power systems, the first target load comprises a target threshold value; and the control circuitry is further configured to determine the first load by determining that a magnitude of the first measured load is higher than or lower than the target threshold value.

In some example hydraulically powered power systems, the first target load comprises a target value range; and the control circuitry is further configured to determine the first load difference by determining that a magnitude of the first measured load is outside of the target value range.

In some example hydraulically powered power systems, the hydraulically powered power system further comprises a user interface configured to generate a user interface signal, wherein the control circuitry is further configured to determine the first target load based on the user interface signal.

In some example hydraulically powered power systems, the hydraulically powered power system further comprises output equipment configured to receive the electrical output from the generator and generate an output equipment signal, wherein the control circuitry is further configured to determine the first target load based on the output equipment signal.

In some example hydraulically powered power systems, the hydraulically powered power system further comprises a second sensor configured to generate a second feedback signal, wherein the control circuitry is further configured to determine the first target load based on the second feedback signal.

In some example hydraulically powered power systems, the first target load comprises at least one of a predetermined target value, one or more predetermined target threshold values, or a predetermined target value range.

In some example hydraulically powered power systems, the hydraulically powered power system further comprises a hydraulic pump configured to receive input power from the engine and to convert the input power to the input hydraulic flow, wherein the hydraulic motor is hydraulically coupled to the hydraulic motor.

In some example hydraulically powered power systems, the hydraulically powered power system further comprises a vehicle comprising the engine.

Disclosed example hydraulically powered power systems comprise: a hydraulic motor configured to convert an input hydraulic flow to motor power; a generator drivingly coupled to the hydraulic motor and configured to convert the motor power to an electrical output; a first sensor configured to measure a first operating characteristic of the generator and to generate a first feedback signal comprising a first measured operating characteristic associated with the first operating characteristic; and control circuitry configured to: monitor the first feedback signal to determine a first operating characteristic difference based on a first target operating characteristic and the first measured operating characteristic, and upon determining the first operating characteristic difference, output a control signal to control an electric motor to modify a motor speed of the electric motor based on the first operating characteristic difference.

In some example hydraulically powered power systems, the first operating characteristic comprises at least one of: a voltage of the electrical output; a frequency of the electrical output; or a current of the electrical output.

In some example hydraulically powered power systems, the first operating characteristic comprises an operating speed of the generator.

In some example hydraulically powered power systems, the first operating characteristic comprises an operating mode of the generator.

In some example hydraulically powered power systems, the first target operating characteristic comprises at least one of: a target voltage of the electrical output; a target frequency of the electrical output; or a target current of the electrical output.

In some example hydraulically powered power systems, the first target operating characteristic comprises a target operating speed of the generator.

In some example hydraulically powered power systems, the first target operating characteristic comprises a target operating mode of the generator. In some such example hydraulically powered power systems, the control circuitry is further configured to, upon determining that the target operating mode comprises a standby mode indication and that the first operating characteristic difference comprises a difference in operating mode, output the control signal to control the electric motor to operate at a standby speed.

In some example hydraulically powered power systems, the first target operating characteristic comprises a target operating mode of the generator and the control circuitry is further configured to, upon determining that the target operating mode comprises a synchronized speed mode indication and that the first operating characteristic difference comprises a difference in operating mode of the generator, output the control signal to control the electric motor to operate at a synchronized motor speed based on a target value of the first target operating characteristic.

In some example hydraulically powered power systems, the first target operating characteristic comprises a target operating mode of the generator and the control circuitry is further configured to, upon determining that the target operating mode comprises a variable mode indication and that the first operating characteristic difference comprises a difference in operating mode of the generator, output the control signal to control the electric motor to operate at a variable motor speed based on a variable target value of the first target operating characteristic.

In some example hydraulically powered power systems, the first target operating characteristic comprises a target operating mode of the generator and the control circuitry is further configured to, upon determining that the target operating mode comprises a fixed speed mode indication and that the first operating characteristic difference comprises a difference in operating mode of the generator, output the control signal to control the electric motor to operate at a fixed motor speed based on a target value of the first target operating characteristic.

In some example hydraulically powered power systems, the first target operating characteristic comprises a target value; and the control circuitry is further configured to determine the first operating characteristic difference by determining a difference between a magnitude of the first measured operating characteristic and the target value.

In some example hydraulically powered power systems, the first target operating characteristic comprises a target threshold value; and the control circuitry is further configured to determine the first operating characteristic by determining that a magnitude of the first measured operating characteristic is higher than or lower than the target threshold value.

In some example hydraulically powered power systems, the first target operating characteristic comprises a target value range; and the control circuitry is further configured to determine the first operating characteristic difference by determining that a magnitude of the first measured operating characteristic is outside of the target value range.

In some example hydraulically powered power systems, the hydraulically powered power system further comprises a user interface configured to generate a user interface signal, wherein the control circuitry is further configured to determine the first target operating characteristic based on the user interface signal.

In some example hydraulically powered power systems, the hydraulically powered power system further comprises output equipment configured to receive the electrical output from the generator and generate an output equipment signal, wherein the control circuitry is further configured to determine the first target operating characteristic based on the output equipment signal.

In some example hydraulically powered power systems, the hydraulically powered power system further comprises a second sensor configured to generate a second feedback signal, wherein the control circuitry is further configured to determine the first target operating characteristic based on the second feedback signal.

In some example hydraulically powered power systems, the first target operating characteristic comprises at least one of a predetermined target value, one or more predetermined target threshold values, or a predetermined target value range.

In some example hydraulically powered power systems, the hydraulically powered power system further comprises a hydraulic pump configured to receive input power from the electric motor and to convert the input power to the input hydraulic flow, wherein the hydraulic motor is hydraulically coupled to the hydraulic motor.

In some example hydraulically powered power systems, the hydraulically powered power system further comprises output equipment configured to receive the electrical output from the generator; and a second sensor configured to measure a load of the output equipment and to generate a second feedback signal comprising a measured load associated with the load, wherein the control circuitry is further configured to: monitor the second feedback signal to determine a load difference based on a target load and the measured load, and upon determining the load difference, output the control signal to control the electric motor to modify the motor speed based on the load difference.

In some example hydraulically powered power systems, the hydraulically powered power system further comprises a second sensor configured to measure a second operating characteristic of the generator and to generate a second feedback signal comprising a second measured operating characteristic associated with the second operating characteristic, wherein the control circuitry is further configured to: monitor the second feedback signal to determine a second operating characteristic difference based on a second target operating characteristic and the second measured operating characteristic; and upon determining the second operating characteristic difference, output the control signal to control the electric motor to modify the motor speed based on the second operating characteristic difference.

In some example hydraulically powered power systems, the control circuitry is further configured to: determine a second target operating characteristic different from the first target operating characteristic; monitor the first feedback signal to determine a second operating characteristic difference based on the second target operating characteristic and the first measured operating characteristic; and upon determining the second operating characteristic difference, output the control signal to control the electric motor to modify the motor speed based on the second operating characteristic difference.

In some example hydraulically powered power systems, the hydraulically powered power system further comprises a vehicle comprising the electric motor.

Disclosed example hydraulically powered power systems comprise: a hydraulic motor configured to convert an input hydraulic flow to motor power; a generator drivingly coupled to the hydraulic motor and configured to convert the motor power to an electrical output; output equipment configured to receive the electrical output from the generator; a first sensor configured to measure a first load of the output equipment and to generate a first feedback signal comprising a first measured load associated with the first load; and control circuitry configured to: monitor the first feedback signal to determine a first load difference based on a first target load and the first measured load; and upon determining the first load difference, output a control signal to control an electric motor to modify a motor speed of the electric motor based on the first load difference.

In some example hydraulically powered power systems, the first target load comprises a target value; and the control circuitry is further configured to determine the first load difference by determining a difference between a magnitude of the first measured load and the target value.

In some example hydraulically powered power systems, the first target load comprises a target threshold value; and the control circuitry is further configured to determine the first load by determining that a magnitude of the first measured load is higher than or lower than the target threshold value.

In some example hydraulically powered power systems, the first target load comprises a target value range; and the control circuitry is further configured to determine the first load difference by determining that a magnitude of the first measured load is outside of the target value range.

In some example hydraulically powered power systems, the hydraulically powered power system further comprises a user interface configured to generate a user interface signal, wherein the control circuitry is further configured to determine the first target load based on the user interface signal.

In some example hydraulically powered power systems, the hydraulically powered power system further comprises output equipment configured to receive the electrical output from the generator and generate an output equipment signal, wherein the control circuitry is further configured to determine the first target load based on the output equipment signal.

In some example hydraulically powered power systems, the hydraulically powered power system further comprises a second sensor configured to generate a second feedback signal, wherein the control circuitry is further configured to determine the first target load based on the second feedback signal.

In some example hydraulically powered power systems, the first target load comprises at least one of a predetermined target value, one or more predetermined target threshold values, or a predetermined target value range.

In some example hydraulically powered power systems, the hydraulically powered power system further comprises a hydraulic pump configured to receive input power from the electric motor and to convert the input power to the input hydraulic flow, wherein the hydraulic motor is hydraulically coupled to the hydraulic motor.

In some example hydraulically powered power systems, the hydraulically powered power system further comprises a vehicle comprising the electric motor.

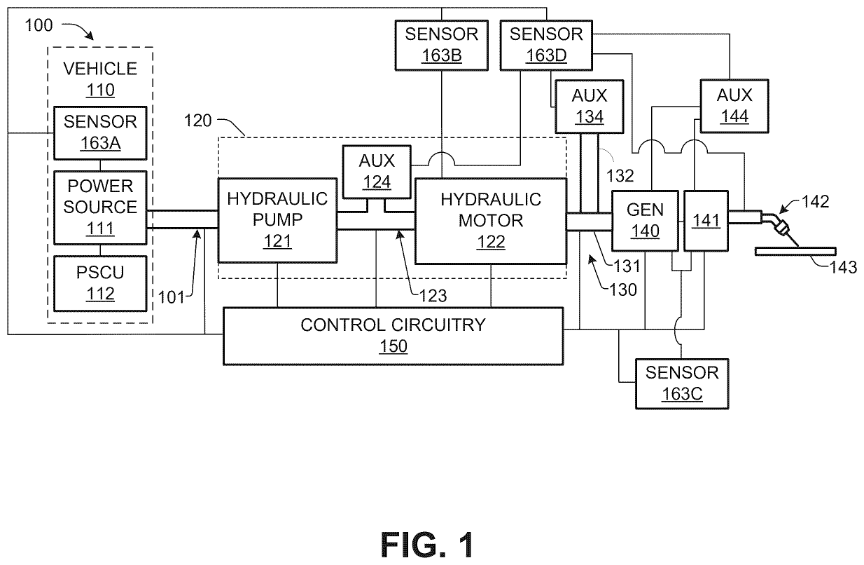

FIG. 1 is a block diagram of an example of a system 100. The system 100 is a hydraulically powered power system, and, in the example depicted in FIG. 1, includes a power source 111, a hydraulic circuit 120, and a generator 140. The power source 111 generates an input power for the hydraulic circuit 120, and, thereby, provides some or all of the power used by the hydraulic circuit 120. In some examples, the power source 111 is and/or includes one or more engines (e.g., one or more vehicular engines, one or more non-vehicular engines, and/or one or more other engines) and/or one or more motors (e.g., one or more electric motors and/or one or more other motors).

In some examples, the power source 111 is and/or includes one or more engines. In the example of FIG. 1, the power source 111 is an engine of a vehicle 110. In some examples, the system 100 does not include the vehicle 110. In some examples, one or more engines of the power source 111 may not be a vehicle's engine (e.g., the system 100 does not include the vehicle 110), and so the system 100 may include the power source 111 (e.g., a non-vehicular engine) but not the vehicle 110. In some examples, the vehicle 110 is a truck, a car, or another vehicle. In some examples, the system 100 may include and/or receive power from any plurality of vehicles including the vehicle 110. In some examples, the vehicle 110 may include a plurality of power sources including the power source 111.

In some examples, the power source 111 is and/or includes one or more motors. In some such examples, the power source 111 includes one or more electric motors. In some examples, the system 100 includes the vehicle 110 and the power source 111 may be and/or include an electric motor of the vehicle 110. In some examples, one or more motors of the power source 111 may not be a vehicle's motor (e.g., the system 100 does not include the vehicle 110).

The hydraulic circuit 120 includes a hydraulic pump 121, and the hydraulic pump 121 may be drivingly coupled to the power source 111. For example, a first linkage 101 may drivingly couple the hydraulic pump 121 to the power source 111 by, e.g., being directly coupled to the power source 111, coupling to a drive shaft rotated by the power source 111, etc. The first linkage 101 may include one or more drive shafts, one or more clutches, one or more transmissions, one or more belts, one or more gear boxes, one or more keyway couplers, one or more splines, one or more flexible couplers, one or more spider couplers, one or more flex plates, one or more flange mounts, one or more other drive shaft mounts (to, e.g., mount to a drive shaft rotated by the power source 111), and/or one or more other mechanical linkages. Accordingly, the hydraulic pump 121 may receive the input power from the power source 111 and convert the input power to an input hydraulic flow of a hydraulic fluid (e.g., hydraulic oil). The hydraulic pump 121 receives the hydraulic fluid from or via, e.g., a fluid reservoir of the hydraulic circuit 120, a fluid return line of the hydraulic circuit 120, etc.

The hydraulic circuit 120 also includes a hydraulic motor 122, which is hydraulically coupled to the hydraulic pump 121. For example, a second linkage 123 (e.g., one or more pipes, one or more valves, and/or one or more other hydraulic linkages) of the hydraulic circuit 120 may hydraulically couple the hydraulic motor 122 to the hydraulic pump 121. Accordingly, the hydraulic motor 122 may receive the input hydraulic flow and convert the input hydraulic flow to motor power.

In some examples, the hydraulic pump 121 is directly driven by the power source 111, such as by the first linkage 101 including a drive shaft directly coupling the power source 111 to the hydraulic pump 121. In some examples, the hydraulic pump 121 is indirectly driven by the power source 111, such as by being coupled by one or more linkages of the first linkage 101 and/or by one or more other intervening components and/or devices. In some examples, the hydraulic circuit 120 includes the hydraulic pump 121 as the sole hydraulic pump of the hydraulic circuit 120. In other examples, the hydraulic circuit 120 may include a plurality of hydraulic pumps including the hydraulic pump 121 and one or more additional hydraulic pumps. In some such examples, functions of the hydraulic pump 121 described herein may be performed individually by the hydraulic pump 121 and/or collectively by a plurality of hydraulic pumps including the hydraulic pump 121. In some examples, one or more hydraulic pumps of a plurality of hydraulic pumps of the hydraulic circuit 120 receive a respective input power from a respective power source (e.g., by the system 100 including one or more power sources in addition to the power source 111). In some examples, the power source 111 provides the input power to a plurality of hydraulic pumps including the hydraulic pump 121. In some examples, the hydraulic pump 121 is a fixed displacement pump. In some examples, the hydraulic pump 121 is a variable displacement pump. In some examples, the hydraulic pump 121 has a range of operating pressures, which can be, in some such examples, between approximately 2,500 and 4,500 pounds per square inch (“psi”). In some examples, the hydraulic pump 121 has a range of operating flow rates, and, in some such examples, the hydraulic pump 121 may, thereby, vary a flow rate of the input hydraulic flow received by the hydraulic motor 122.

In some examples, the power source 111 is a single power source (e.g., a single engine or a single motor). In some examples, the power source 111 includes a plurality of power sources (e.g., a plurality of engines, a plurality of motors, one or more engines and one or more motors, etc.). In some examples, the system 100 includes a plurality of power sources including the power source 111. In some such examples, two or more of the power sources of the plurality of power sources may provide a combined input power to the hydraulic circuit 120 (e.g., a singular input power generated by a plurality of power sources and provided to the hydraulic circuit 120 via a single linkage of the first linkage 101) and/or one or more of the power sources of the plurality of power sources may each provide an independent input power to the hydraulic circuit 120 (e.g., an input power generated by only one power source and provided to the hydraulic circuit 120 via a respective linkage of the first linkage 101).

In some examples, the hydraulic circuit 120 includes the hydraulic motor 122 as the sole hydraulic motor of the hydraulic circuit 120. In other examples, the hydraulic circuit 120 may include a plurality of hydraulic motors including the hydraulic motor 122 and one or more additional hydraulic motors. In some such examples, functions of the hydraulic motor 122 described herein may be performed individually by the hydraulic motor 122 and/or collectively by a plurality of hydraulic motors including the hydraulic motor 122. In some examples, the system 100 includes a plurality of hydraulic circuits (one or more of the hydraulic circuits being, e.g., configured similarly to the hydraulic circuit 120, configured differently from the hydraulic circuit 120, drivingly coupled to the power source 111, drivingly coupled to one or more other power sources, etc.). In some such examples, one or more hydraulic motors of a plurality of hydraulic motors of the hydraulic circuit 120 and/or one or more additional hydraulic circuits receive a respective input hydraulic flow from a respective hydraulic pump. In some examples, the hydraulic pump 121 provides the input hydraulic flow to a plurality of hydraulic motors including the hydraulic motor 122. In some examples, the hydraulic motor 122 is a fixed displacement hydraulic motor. In some examples, the hydraulic motor 122 is a variable displacement hydraulic motor.

In some examples, the hydraulic circuit 120 may additionally include one or more first auxiliary devices 124. The second linkage 123 and/or one or more other linkages may hydraulically couple the one or more first auxiliary devices 124 to the hydraulic pump 121. The hydraulic pump 121 may, thereby, additionally and/or alternatively provide the input hydraulic flow and/or another hydraulic flow to the one or more first auxiliary devices 124 to provide the one or more first auxiliary devices 124 with hydraulic power. In examples, the one or more first auxiliary devices 124 may include one or more of any, some, or all of a hydraulic motor, an air compressor, a welder, an outrigger, a truck stabilizer, a crane, a hydraulic lift, a grinder, and/or one or more other hydraulically powered tools and/or devices. In some examples, the hydraulic pump 121 provides the input hydraulic flow and/or another hydraulic flow to only one of the one or more first auxiliary devices 124. In some examples, the hydraulic pump 121 provides the input hydraulic flow and/or another hydraulic flow to any plurality of the one or more first auxiliary devices 124. In some examples, the hydraulic pump 121 provides the input hydraulic flow and/or another hydraulic flow to none of the one or more first auxiliary devices 124. In some examples, the hydraulic circuit 120 includes any, some, or all of the one or more first auxiliary devices 124. In other examples, the hydraulic circuit 120 includes none of the one or more first auxiliary devices 124.

The generator 140 is drivingly coupled to the hydraulic motor 122. For example, a drive assembly 130 may drivingly couple the hydraulic motor 122 to the generator 140 via a third linkage 131. The third linkage 131 may include one or more drive shafts, one or more clutches, one or more transmissions, one or more belts, one or more gear boxes, one or more keyway couplers, one or more splines, one or more flexible couplers, one or more spider couplers, one or more flex plates, one or more flange mounts, one or more other drive shaft mounts, and/or one or more other mechanical linkages. By being drivingly coupled to the hydraulic motor 122, the generator 140 may convert the motor power to an electrical output (e.g., AC power and/or DC power). In some examples, the generator 140 is directly driven by the hydraulic motor 122, such as by the third linkage 131 including a drive shaft directly coupling the hydraulic motor 122 to the generator 140. In some examples, the generator 140 is indirectly driven by the hydraulic motor 122, such as by being coupled by one or more linkages of the third linkage 131 and/or by one or more other intervening components and/or devices. In some examples, the third linkage 131 directly couples and/or integrates the generator 140 with the hydraulic motor 122. For instance, the generator 140 and the hydraulic motor 122 may be enclosed within a single housing or otherwise physically coupled.

In some examples, the drive assembly 130 may additionally and/or alternatively provide the motor power to one or more second auxiliary devices 134. For example, a fourth linkage 132 may additionally couple to the hydraulic motor 122 and/or couple to the third linkage 131 to direct some or all of the motor power away from the generator 140 and toward the one or more second auxiliary devices 134. The fourth linkage 132 may include one or more drive shafts, one or more clutches, one or more transmissions, one or more belts, one or more gear boxes, one or more keyway couplers, one or more splines, one or more flexible couplers, one or more spider couplers, one or more flex plates, one or more flange mounts, one or more other drive shaft mounts (to, e.g., mount to a drive shaft of the third linkage 131), and/or one or more other mechanical linkages. In examples, the one or more second auxiliary devices 134 may include one or more of any, some, or all of a generator, a motor, an air compressor, a welder, an outrigger, a pump, a truck stabilizer, a crane, a lift, a grinder, and/or one or more other mechanically powered tools and/or devices. In some examples, the hydraulic motor 122 provides the motor power to only one of the one or more second auxiliary devices 134. In some examples, the hydraulic motor 122 provides the motor power to any plurality of the one or more second auxiliary devices 134. In some examples, the hydraulic motor 122 provides the motor power to none of the one or more second auxiliary devices 134. In some examples, the system 100 includes any, some, or all of the one or more second auxiliary devices 134. In other examples, the system 100 includes none of the one or more second auxiliary devices 134.

The generator 140 may provide the electrical output to one or more tools and/or devices. The generator 140 may additionally and/or alternatively provide the electrical output to a power conversion circuitry 141 (e.g., an individual or combined generator and/or welding power supply). The power conversion circuitry 141 may be used to condition and/or regulate the electrical output of the generator 140 for usage by one or more other devices, such as by converting the electrical output to welding power. In some examples, the conditioned and/or regulated power output can be described as a synthetic auxiliary output, with the power being converted over a range of voltage and/or current output curves and/or over a range of values (e.g., 120-240 V, 15-500 amps (“A”), at 50-60 Hz). In some examples, the system 100 is configured such that the generator 140 provides a power output for the power conversion circuitry 141 to convert the electrical output from the generator 140 to a synchronous AC power output. The power conversion circuitry 141 may include one or more AC-DC converters, one or more preregulators, and/or one or more other types of converters and/or power conversion circuitries configured to convert input power (e.g., AC power) to one or more other types of power (e.g., DC power, welding power, etc.). In some examples, the power conversion circuitry 141, which receives a variable AC input from the generator 140, is configured to generate the synchronous AC power output to one or more tools and/or devices.

In some examples, the generator 140 and/or the power conversion circuitry 141 provide power for one or more tools 142 (i.e., provide the electrical output to the one or more tools 142). In examples, the one or more tools 142 may include any, some, or all of a welding tool (e.g., a welding torch, a wire feeder, and/or one or more other components of a welding system), a wrench, and/or another device. For example, the one or more tools 142 may include a welding torch, and the power conversion circuitry 141 may provide power to the welding torch to perform a welding and/or cutting operation on a workpiece 143. In some examples, the generator 140 and/or the power conversion circuitry 141 provide power to only one of the tools 142. In some examples, the generator 140 and/or the power conversion circuitry 141 provide power to any plurality of the tools 142. In some examples, the generator 140 and/or the power conversion circuitry 141 provide power to none of the tools 142. In some examples, the system 100 includes any, some, or all of the one or more tools 142. In some examples, the system 100 includes none of the one or more tools 142.

The generator 140 and/or the power conversion circuitry 141 may additionally and/or alternatively provide power to one or more third auxiliary devices 144. For example, the generator 140 may provide the electrical output to any, some or all of the third auxiliary devices 144 and the power conversion circuitry 141 may additionally and/or alternatively regulate the electrical output for any, some, or all of the one or more third auxiliary devices 144. In examples, the one or more third auxiliary devices 144 may include one or more of any, some, or all of a motor, an air compressor, a welder, an auxiliary tool, an outrigger, a pump, a truck stabilizer, a crane, a lift, a grinder, a wrench, lighting, and/or one or more other electrically powered tools and/or devices. In some examples, the generator 140 and/or the power conversion circuitry 141 provide power to only one of the one or more third auxiliary devices 144. In some examples, the generator 140 and/or the power conversion circuitry 141 provide power to any plurality of the one or more third auxiliary devices 144. In some examples, the generator 140 and/or the power conversion circuitry 141 provide power to none of the one or more third auxiliary devices 144. In some examples, the system 100 includes any, some, or all of the one or more third auxiliary devices 144. In other examples, the system 100 includes none of the one or more third auxiliary devices 144.

In some examples, the system 100 does not include the power conversion circuitry 141. In some examples, the system 100 includes the power conversion circuitry 141 as the sole power conversion circuitry of the system 100. In other examples, the system 100 may include a plurality of power conversion circuitries including the power conversion circuitry 141 and one or more additional power conversion circuitries. In some such examples, functions of the power conversion circuitry 141 described herein may be performed individually by the power conversion circuitry 141 and/or collectively by a plurality of power conversion circuitries including the power conversion circuitry 141. In some examples, the system 100 includes a plurality of generators. In some such examples, one or more generators of a plurality of generators of the system 100 provide a respective electrical output to one or more respective power conversion circuitries of a plurality of power conversion circuitries. In some examples, the generator 140 provides the electrical output to a plurality of power conversion circuitries including the power conversion circuitry 141.

In some examples, the system 100 includes the generator 140 as the sole generator of the system 100. In other examples, the system 100 may include a plurality of generators including the generator 140 and one or more additional generators. In some such examples, functions of the generator 140 described herein may be performed individually by the generator 140 and/or collectively by a plurality of generators including the generator 140. In some examples, the system 100 includes a plurality of hydraulic motors (e.g., by including a plurality of hydraulic circuits and/or by the hydraulic circuit 120 including a plurality of hydraulic motors) and/or one or more other type(s) of motors. In some such examples, one or more generators of a plurality of generators of the system 100 receive a respective motor power from a respective hydraulic motor and/or other type of motor. In some examples, the hydraulic motor 122 provides the motor power to a plurality of generators including the generator 140.

In the example of FIG. 1, the system 100 includes a control circuitry 150. In some examples, the control circuitry 150 is and/or includes one or more control circuitries integrated into one or more components, systems, and/or devices of the system 100 (e.g., as a computing device electrically coupled to the generator 140 and integrated into a housing of the generator 140). In some additional and/or alternative examples, the control circuitry 150 is and/or includes one or more remote control circuitries (e.g., one or more cloud computing devices and/or systems, one or more cloud memory storage devices and/or systems, one or more remote controls, one or more smartphones, one or more laptops, etc.) which may, e.g., remotely transmit and/or receive signals to one or more components, systems, and/or devices of the system 100.

In some examples, the control circuitry 150 includes and/or is electrically coupled to (i.e., transmit and/or receive one or more signals to and/or from) one or more power source control units (“PSCUs”) associated with the power source 111 and/or one or more other power sources. In the example of FIG. 1, the vehicle 110 includes a PSCU 112 that controls one or more operating characteristics (e.g., an engine speed, a motor speed, a torque, an operating mode, etc.) of the power source 111.

As used herein, the terms “power source control unit” and “PSCU” refer to one or more control circuitries which may control and/or electrically communicate with some or all of the operation of one or more power sources (e.g., the power source 111 and/or one or more other power sources). In some examples, a PSCU (e.g., the PSCU 112) may be and/or include an engine control unit (“ECU”) of a vehicle (e.g., the vehicle 110) that controls (in whole or in part) an engine (e.g., the power source 111) of the vehicle. In some examples, a PSCU (e.g., the PSCU 112) may be and/or include a motor control unit (“MCU”) that controls (in whole or in part) a motor (e.g., the power source 111). In some such examples, a PSCU (e.g., the PSCU 112) may be an MCU of a vehicle (e.g., the vehicle 110) and may be integrated into, combined with, and/or otherwise working in coordination with an ECU of the vehicle. In some examples, a PSCU (e.g., the PSCU 112) may modify one or more operating characteristics (e.g., an engine speed, a torque, an operating mode, etc.) of one or more engines (e.g., an engine of the power source 111), modify one or more other operating characteristics (e.g., a motor speed, a torque, an operating mode, etc.) of one or more motors (e.g., an electric motor of the power source 111), receive a feedback signal from one or more engines (e.g., an engine of the power source 111), one or more motors (e.g., an electric motor of the power source 111), one or more other power sources, and/or one or more sensors (e.g., a power source sensor), transmit and/or receive a control signal (e.g., receive a control signal from the control circuitry 150 comprising an instruction to modify an engine speed of an engine of the power source 111 and/or to modify a motor speed of an electric motor of the power source 111), and/or perform one or more other functions relating to one or more power sources (e.g., an engine of the power source 111 and/or an electric motor of the power source 111). A PSCU (e.g., the PSCU 112) may include any, some, or all of the components, functionalities, and/or other features and/or aspects of the control circuitry 150, as described elsewhere herein.

In the example of FIG. 1, the PSCU 112 is a component of the vehicle 110. In other examples, the PSCU 112 may be, include a component of, and/or be a component of one or more control circuitries of the vehicle 110, the power source 111, a remote control circuitry (e.g., one or more cloud computing devices and/or systems, one or more cloud memory storage devices and/or systems, one or more remote controls, one or more smartphones, one or more laptops, etc.), the control circuitry 150, and/or one or more other control circuitries.

In some examples, the PSCU 112 controls the power source 111 independently. In some additional and/or alternative examples, the PSCU 112 controls the power source 111 in coordination with one or more other control circuitries, such as by controlling only one or more aspects and/or components of the power source 111. In some additional and/or alternative examples, the PSCU 112 controls the power source 111 under the partial and/or total control of one or more control circuitries (e.g., the control circuitry 150), such as by modifying an engine speed and/or a motor speed of an engine and/or an electric motor of the power source 111 based on an instruction (e.g., to increase the engine speed and/or to increase the motor speed) received in and/or determined using a control signal transmitted by the control circuitry 150. In some additional and/or alternative examples, the PSCU 112 controls the power source 111 under the partial and/or total control of one or more user interfaces, such as by modifying an engine speed and/or a motor speed of an engine and/or an electric motor of the power source 111 based on an instruction (e.g., to increase the engine speed and/or to increase the motor speed) received in and/or determined using a user interface signal transmitted by a user interface.

The control circuitry 150 may be electrically coupled to one or more devices, systems, and or components of the system 100. For example, the control circuitry 150 may electrically communicate with one or more devices, systems, and or components of the system 100, such as by transmitting and/or receiving one or more signals to and/or from one or more devices, systems, and or components of the system 100 (e.g., feedback signals, control signals, user interface signals, output equipment signals, input signals, etc.). In some examples, the control circuitry 150 may directly and/or indirectly control one or more devices, systems, and/or components of the system 100. For example, the control circuitry 150 may directly control one or more devices, systems, and/or components of the system 100 (e.g., a welding torch of the one or more tools 142, the power source 111, etc.) by transmitting a control signal that controls the one or more devices, systems, and/or components of the system 100 to modify a function, an operation, one or more operation characteristics, etc. of the one or more devices, systems, and/or components of the system 100 (e.g., controlling the welding torch of the one or more tools 142 to turn on/off, modifying an engine speed of the power source 111, modifying a motor speed of the power source 111, modifying a torque of the power source 111, etc.). As an additional and/or alternative example, the control circuitry 150 may indirectly control one or more devices, systems, and/or components of the system 100 (e.g., an air compressor of the one or more second auxiliary devices 134, the power source 111, etc.) by transmitting a control signal to the one or more devices, systems, and/or components of the system 100 that includes an instruction to modify a function, an operation, one or more operation characteristics, etc. of the one or more devices, systems, and/or components of the system 100 (e.g., instructing an air compressor of the one or more second auxiliary devices 134 to turn off, instructing the PSCU 112 to modify an engine speed and/or a motor speed of an engine and/or an electric motor of the power source 111, etc.).

The control circuitry 150 may be electrically coupled to any, some, or all of the first linkage 101, the vehicle 110, the power source 111, the PSCU 112, the hydraulic circuit 120, the hydraulic pump 121, the hydraulic motor 122, the second linkage 123, the one or more first auxiliary devices 124, the drive assembly 130, the third linkage 131, the fourth linkage 132, the one or more second auxiliary devices 134, the generator 140, the power conversion circuitry 141, the one or more tools 142, and/or the one or more third auxiliary devices 144. In some examples, the control circuitry 150 is a plurality of control circuitries. In some additional and/or alternative examples, the control circuitry 150 is and/or includes one or more remote control circuitries (e.g., one or more cloud computing devices and/or systems, one or more cloud memory storage devices and/or systems, one or more remote controls, one or more smartphones, one or more laptops, etc.). In some additional and/or alternative examples, the control circuitry 150 functions in coordination with one or more other control circuitries (e.g., one or more other control circuitries of the system 100, one or more remote control circuitries, etc.).

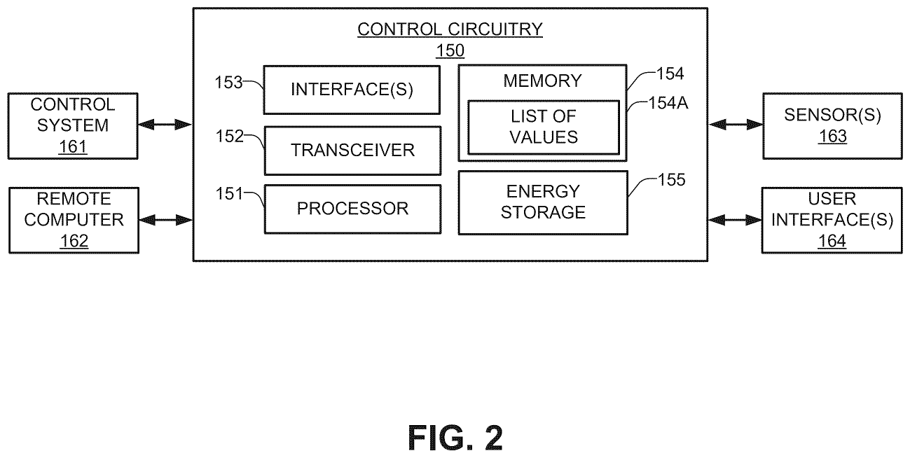

FIG. 2 is a block diagram of an example of the control circuitry 150, which can be configured as a microcontroller, or to include a processor 151, to perform as a programmable logic circuit, a system-on-chip, a programmable logic device, and/or any other type of logic circuit. The control circuitry 150 can be included in one or more components of the system 100 (e.g., the vehicle 110 and/or one or more components thereof (e.g., the PSCU 112), the hydraulic circuit 120 and/or one or more components thereof, the generator 140, the power conversion circuitry 141, the one or more tools 142, any, some, or all of the auxiliary devices 124, 134, 144, etc.), and/or be implemented as one or more remote computers 162 and/or as another control device.

In some examples, the control circuitry 150 can include one or more transceivers 152 to communicate with, e.g., the vehicle 110, one or more control systems 161 (e.g., the PSCU 112, a control system of the hydraulic circuit 120, a control system of the generator 140, a control system of the power conversion circuitry 141, one or more control systems of the one or more tools 142, one or more control systems of any, some, or all of the auxiliary devices 124, 134, 144, etc.), the one or more remote computers 162 (e.g., one or more cloud computing devices and/or systems, one or more cloud memory storage devices and/or systems, one or more remote controls, one or more smartphones, one or more laptops, etc.), a sensor system 163, a user interface 164, one or more other devices, components, and/or systems of the system 100, etc. One or more interfaces 153 can be included with or connected to the control circuitry 150, e.g., to provide a communications link with any, some, or all of the vehicle 110, the PSCU 112, the one or more control systems 161, the remote computer 162), the sensor system 163, the user interface 164, one or more other devices, components, and/or systems of the system 100, etc.

In some examples, the control circuitry 150 includes a memory storage device 154, and/or an energy storage device 155. For example, information related to operating characteristics, target operating characteristics, measured operating characteristics, etc., can be stored in a list of values 154A, e.g., as a chart, a library, etc., within the memory storage device 154.

In some examples, the system 100 can include the user interface 164 (e.g., a switch, a computer input device, etc.) to provide options for an operator to control the system 100 and/or one or more components thereof. In some examples, the user interface 164 includes a plurality of user interfaces.

Additionally or alternatively, one or more component may be in direct communication with another component, for example, one or more of the various system components (e.g., the control circuitry 150) can be directly linked to any one or more of the other components (e.g., the vehicle 110, the PSCU 112, the generator 140, the power conversion circuitry 141, one or more of the tools 142, and/or any, some, or all of the auxiliary devices 124, 134, 144) to facilitate communication.

In some disclosed examples, the control circuitry 150 monitors one or more operating characteristics of the system 100 or various devices, components, and/or systems thereof. In examples, the control circuitry 150 monitors any, some, or all of the input power, the input hydraulic flow, the motor power, the electrical output, and/or functioning of the vehicle 110, the power source 111, the hydraulic pump 121, the hydraulic motor 122, the generator 140, the power conversion circuitry 141, the one or more tools 142, any, some, or all of the auxiliary devices 124, 134, 144, and/or any, some, or all of the linkages 101, 123, 131, 132.

In some examples, the control circuitry 150 monitors one or more operating characteristics of the system 100 via a sensor system 163. The sensor system 163 may include one or more sensors, and each of the one or more sensors of the sensor system 163 may monitor one or more components and/or operating characteristics of the system 100. Each of the one or more sensors of the sensor system 163 may produce one or more feedback signals (e.g., a signal comprising and/or usable to determine one or more measured values and/or one or more measured operating characteristics), and each feedback signal may include one or more measured operating characteristics of one or more components of the system 100.

Referring again to FIG. 1, and with reference to FIG. 2, the sensor system 163 may include one or more of one or more power source sensors 163A, one or more motor sensors 163B, one or more generator sensors 163C, one or more output equipment sensors 163D, and/or one or more other sensors.

In examples, the one or more power source sensors 163A may measure operating characteristics of the vehicle 110, operating characteristics of the power source 111, operating characteristics of one or more other power sources of the system 100, and/or an environment of the vehicle 110, and/or one or more other aspects, qualities, and/or characteristics of the power source 111 and/or one or more other power sources of the system 100. For example, the one or more power source sensors 163A may measure an engine speed of an engine of the power source 111, a motor speed of a motor (e.g., an electric motor) of the power source 111, a torque of the power source 111 (i.e., a torque generated by an engine and/or an electric motor of the power source 111), an operating mode of the power source 111 (e.g., an off mode, an on mode, a standby mode, an active mode, a synchronized speed mode, a variable speed mode, a fixed speed mode, etc.), one or more other characteristics of the input power, a temperature, pressure, or other characteristic of an environment of the vehicle 110 and/or the power source 111, etc. In some examples, any, some, or all of the one or more power source sensors 163A may be a component of the PSCU 112 and/or the control circuitry 150 (e.g., as an electrical feedback loop). In examples, the one or more power source sensors 163A may comprise one or more of any, some, or all of a thermometer, a pressure sensor, a weight sensor, a torque sensor, a tachometer, a voltmeter, a photoelectric speed sensor, a Hall effect sensor, an application specific integrated circuit (“ASIC”) sensor, a Hall ASIC sensor, a magnetic pickup sensor, and/or one or more other sensors (e.g., one or more sensors described elsewhere herein). In examples, the one or more power source sensors 163A may provide one or more feedback signals comprising one or more measured operating characteristics (e.g., a measured engine speed, a measured motor speed, a measured torque, etc.) to the control circuitry 150 and/or the PSCU 112. In some examples, any, some, or all of the power source sensors 163A may be a component of the control circuitry 150 and/or a component of the PSCU 112 (e.g., as an electrical feedback loop).

In examples, the one or more motor sensors 163B may measure operating characteristics and/or an environment of the hydraulic motor 122 and/or one or more other motors of the system 100. For example, the one or more motor sensors 163B may measure any, some, or all of a flow rate of the input hydraulic flow within the hydraulic circuit 120 and/or through the hydraulic motor 122, a pressure within the hydraulic motor 122 and/or the second linkage 123, a temperature, heat output, and/or oil weight of the hydraulic fluid within the hydraulic motor 122 and/or the second linkage 123, a temperature, pressure, or other characteristic of an environment of the hydraulic motor 122 and/or the hydraulic circuit 120, an operating speed (e.g., in RPM) of the hydraulic motor 122 and/or a torque generated by the hydraulic motor 122, and/or a motor power generated by the hydraulic motor 122 and provided to the drive assembly 130 (e.g., output torque, operating speed, etc.). In examples, the one or more motor sensors 163B may comprise one or more of any, some, or all of a flowmeter, a thermometer, a pressure sensor, a weight sensor, a torque sensor, a tachometer, a voltmeter, a photoelectric speed sensor, a Hall effect sensor, an ASIC sensor, a Hall ASIC sensor, a magnetic pickup sensor, and/or one or more other sensors (e.g., one or more sensors described elsewhere herein). In examples, the one or more motor sensors 163B may provide one or more feedback signals comprising one or more measured operating characteristics (e.g., a measured flow rate, a measured pressure, a measured operating speed, a measured torque, etc.) to the control circuitry 150.

In examples, the one or more generator sensors 163C may measure operating characteristics and/or an environment of the generator 140 and/or the power conversion circuitry 141. For example, the one or more generator sensors 163C may measure any, some, or all of a voltage and/or an amperage of the electrical output, an operating frequency (e.g., in Hz) of the electrical output, an operational mode (e.g., an off mode, an on mode, an active mode, a standby mode, a synchronized speed mode, a variable speed mode, a fixed speed mode, etc.) of the generator 140 and/or the power conversion circuitry 141, an operating speed (e.g., in RPM) of the generator 140, a temperature, pressure, or other characteristic of an environment of the generator 140 and/or the power conversion circuitry 141, and/or motor power received by the generator 140 from the drive assembly 130 (e.g., input torque, operating speed, etc.). In examples, the one or more generator sensors 163C may comprise one or more of any, some, or all of a voltmeter, a current sensor, a frequency sensor, an EMF sensor, a torque sensor, a tachometer, a pressure sensor, a thermometer, a photoelectric speed sensor, a Hall effect sensor, an ASIC sensor, a Hall ASIC sensor, a magnetic pickup sensor, an electrical feedback loop, and/or one or more other sensors (e.g., one or more sensors described elsewhere herein). In examples, the one or more generator sensors 163C may provide one or more feedback signals comprising one or more measured operating characteristics (e.g., a measured operating speed, a measured voltage, a measured current, a measured frequency, a measured operating state, etc.) to the control circuitry 150. In some examples, any, some, or all of the generator sensors 163C may be a component of the control circuitry 150 (e.g., as an electrical feedback loop).

In examples, the one or more output equipment sensors 163D may measure operating characteristics and/or an environment of any, some, or all output equipment of the system 100. Output equipment of the system 100 may include any, some, or all of the one or more tools 142, any, some, or all of the auxiliary devices 124, 134, 144, and/or one or more other devices, systems and/or components receiving power from the system 100 and/or one or more devices, systems, and/or components thereof. In examples, the one or more output equipment sensors 163D may measure any, some, or all of a voltage and/or an amperage of an input hydraulic flow received by the one or more first auxiliary devices 124, a motor power received by the one or more second auxiliary devices 134, an electrical output received by the one or more tools 142 and/or the one or more third auxiliary devices 144, a load demand of any, some, or all of the output equipment of the system 100 (e.g., a torque, operating speed, voltage, current, frequency, operating mode, etc.), an air and/or fluid pressure of any, some, or all of the output equipment of the system 100 (e.g., air pressure of one or more air compressors), an air and/or fluid flow of any, some, or all of the output equipment of the system 100 (e.g., air flow of one or more compressors), a temperature and/or pressure of an environment of any, some, or all of the output equipment of the system 100, and/or a desired load demand of any, some, or all of the output equipment of the system 100. In examples, the one or more output equipment sensors 163D may comprise one or more of any, some, or all of a voltmeter, a current sensor, an EMF sensor, a torque sensor, a tachometer, a pressure sensor, an air pressure sensor, an air flow sensor, a thermometer, a photoelectric speed sensor, a Hall effect sensor, an ASIC sensor, a Hall ASIC sensor, a magnetic pickup sensor, an electrical feedback loop, and/or one or more other sensors (e.g., one or more sensors described elsewhere herein). In examples, the one or more output equipment sensors 163D may provide one or more feedback signals comprising one or more measured operating characteristics (e.g., a measured load demand) to the control circuitry 150. In some examples, any, some, or all of the output equipment sensors 163D may be a component of the control circuitry 150 (e.g., as an electrical feedback loop).

In examples, the system 100 may include one, none, and/or any plurality of any, some, or all of the sensors 163A, 163B, 163C, 163D. In examples, the system 100 may include one or more additional sensors to measure one or more additional operating characteristics of the system 100 and/or one or more components, devices, and/or systems of the system 100.

The control circuitry 150 controls the system 100 and/or one or more components, devices, and/or systems of the system 100, e.g., by outputting a control signal to one or more of the components. Accordingly, the control circuitry 150 may control the system 100 and/or one or more components thereof based on measured operating characteristics of the system 100 and/or one or more components thereof. The control circuitry 150 may receive such measured operating characteristics via one or more feedback signals generated by one or more of the sensors 163A, 163B, 163C, 163D and/or via one or more other signals. Accordingly, one or more signals may trigger an automatic response by the control circuitry 150 to control one or more components of the system 100. This response may include directly or indirectly adjusting an operating characteristic associated with one or more components of the system 100. In examples, control of the system 100 and/or one or more components thereof can be regulated by the control circuitry 150. In examples, the control circuitry 150 can adjust (directly and/or indirectly) one or more operating characteristics of any, some, or all of the vehicle 110, the power source 111, the hydraulic circuit 120, the hydraulic pump 121, the hydraulic motor 122, the one or more first auxiliary devices 124, the drive assembly 130, the one or more second auxiliary devices 134, the generator 140, the power conversion circuitry 141, the one or more tools 142, and/or the one or more third auxiliary devices 144. Furthermore, one or more of the linkages 101, 123, 131, 132 may be controlled to completely and/or partially engage or disengage in response to the one or more operating characteristics.

For example, the control circuitry 150 may monitor one or more measured operating characteristics of the generator 140. In some examples, the one or more generator sensors 163C measure one or more operating characteristics of the generator 140 and generate one or more feedback signals comprising one or more measured operating characteristics associated with the one or more operating characteristics. In examples, operating characteristics measured by the one or more generator sensors 163C include any, some, or all of a voltage of the electrical output of the generator 140 (e.g., in volts), a frequency of the electrical output of the generator 140 (e.g., in hertz), a current of the generator 140 (e.g., in amps), an operating speed of the generator 140 (e.g., in RPM), and/or an operating mode of the generator 140 (e.g., an on mode, an off mode, a standby mode, an active mode, a synchronized speed mode, a variable speed mode, and/or a fixed speed mode). The one or more generator sensors 163C may measure one or more operating characteristics and/or generate one or more feedback signals constantly, at a time interval, upon the satisfaction of one or more trigger events, etc. In examples, the control circuitry 150 monitors one or more feedback signals generated by the generator sensors 163C to determine one or more operating characteristic differences based on the one or more measured operating characteristics and one or more target operating characteristics.

The control circuitry 150 may receive one or more feedback signals from any, some, or all of the sensors 163A, 163B, 163C, 163D and/or one or more other sensors via the one or more transceivers 152, the one or more interfaces 153, and/or one or more other devices, processes, and/or mechanisms. In some examples, a feedback signal generated by any, some, or all of the sensors 163A, 163B, 163C, 163D and/or one or more other sensors and/or received by the control circuitry 150 may include one or more measured operating characteristics. In some examples, the control circuitry 150 may determine (e.g., via calculations, conversions, etc.) one or more measured operating characteristics based on one or more feedback signals generated by any, some, or all of the sensors 163A, 163B, 163C, 163D and/or one or more other sensors.

A target operating characteristic may include any, some, or all of one or more target values (e.g., 24V), one or more threshold values (e.g., ≥23.5V), one or more target value ranges defined by two threshold values (e.g., 23.5-24.5 V), and/or one or more target operating modes. A target operating characteristic associated with the generator 140 may, e.g., include any, some, or all of a target voltage of the electrical output of the generator 140 (e.g., a target voltage value, one or more threshold voltage values, and/or a target voltage range), a target frequency of the electrical output of the generator 140 (e.g., a target frequency value, one or more threshold frequency values, and/or a target frequency range), a target current of the electrical output of the generator 140 (e.g., a target current value, one or more threshold current values, and/or a target current range), a target operating speed of the generator 140 (e.g., a target operating speed value, one or more threshold operating speed values, and/or a target operating speed range), a target operating mode of the generator 140 (e.g., an on mode, an off mode, a standby mode, an active mode, a synchronized speed mode, a variable speed mode, and/or a fixed speed mode), and/or a target operating mode of the power source 111 e.g., an on mode, an off mode, a standby mode, an active mode, a synchronized speed mode, a variable speed mode, and/or a fixed speed mode). In some examples, a target operating mode includes a mode indication (e.g., an on mode indication, an off mode indication, an active mode indication, a standby mode indication, a synchronized speed mode indication, a variable speed mode indication, and/or a fixed speed mode indication) instructing the generator 140 and/or the power source 111 to begin operating in, transition to operating in, and/or continue operating in an indicated operating mode.

In some examples, the control circuitry 150 determines one or more target operating characteristics based on one or more user interface signals (e.g., an indication of one or more target values, one or more target threshold values, and/or one or more target value ranges) generated by the user interface 164 (e.g., via a user inputting information into the user interface 164).

In some examples, the control circuitry 150 determines one or more target operating characteristics based on one or more output equipment signals generated by the one or more tools 142 and/or any, some, or all of the auxiliary devices 124, 134, 144. For example, a user interface of the one or more tools 142 (e.g., a trigger of a welding torch) and/or a user interface of any, some, or all of the auxiliary devices 124, 134, 144 (e.g., a manual switch on an air compressor of the one or more second auxiliary devices 134 and/or of the one or more third auxiliary devices 144) may generate an output equipment signal which comprises and/or may be used to determine a target operating characteristic. As an additional and/or alternative example, a control circuitry of the one or more tools 142 and/or a control circuitry of any, some, or all of the auxiliary devices 124, 134, 144 may generate an output equipment signal which comprises and/or may be used to determine a target operating characteristic.

In some examples, the control circuitry 150 determines one or more target operating characteristics based on one or more feedback signals generated by any, some, or all of the sensors 163A, 163B, 163C, 163D and/or one or more other sensors. As an example, a temperature sensor of the one or more power source sensors 163A may indicate a low temperature that may result in a desire to start an engine of the power source 111 using a slower startup process (and, therefore, controlling an engine speed of the engine to be increased more slowly than otherwise). As an additional and/or alternative example, the one or more output equipment sensors 163D may sense a level of resistance experienced by the one or more tools 142 and/or any, some, or all of the auxiliary devices 124, 134, 144, which may indicate, e.g., that a target value of a target operating characteristic should be raised.

In some examples, a target threshold value and/or a target value range of a target operating characteristic may be determined as a function of one or more percentages of a target value of the target operating characteristic. For example, an upper target threshold voltage value, a lower target threshold voltage value, and/or a target voltage value range of a target voltage may be determined based on 5% of a 24 V target voltage value of the target voltage such that the upper target threshold voltage value is 25.2 V, the lower target threshold voltage value is 22.8 V, and/or the target voltage value range is 22.8-25.2 V. In some examples, an upper target threshold value of a target operating characteristic may be based on a first percentage of a target value of the target operating characteristic, while a lower target threshold value of the target operating characteristic may be based on a second percentage, different from the first percentage, of the target value. In some examples, the control circuitry 150 determines one or more percentages used for calculating one or more target threshold values and/or one or more target value ranges of a target operating characteristic based on one or more user interface signals (e.g., one or more user-input percentages) generated by the user interface 164. In some examples, the control circuitry 150 determines one or more percentages used for calculating one or more target threshold values and/or one or more target value ranges of a target operating characteristic based on one or more magnitudes of one or more target values, one or more threshold target values, and/or one or more target value ranges (e.g., a larger magnitude being associated with a smaller percentage).

In some examples, a target operating characteristic includes at least one of a predetermined target value, one or more predetermined target threshold values, or a predetermined target value range. For example, a predetermined target value (e.g., a target voltage value) may be a default factory setting (e.g., a region-specific standard electrical output). In some examples, a target threshold value and/or a target value range of a target output characteristic may be determined as a function of one or more predetermined percentages of a target value of the target output characteristic. For example, a predetermined percentage used for calculating one or more target threshold values and/or one or more

As used herein, the term “operating characteristic difference” refers to one or more differences between a target operating characteristic and a measured operating characteristic. An operating characteristic may include one or more differences between two or more values and/or one or more determinations.

An operating characteristic difference may include one or more differences between one or more magnitudes of a measured voltage, a measured current, a measured frequency, and/or a measured operating speed and a target voltage value, a target current value, a target frequency value, and/or a target operating speed value, respectively. An operating characteristic difference may additionally and/or alternatively include one or more differences between one or more magnitudes of a measured voltage, a measured current, a measured frequency, and/or a measured operating speed and one or more target threshold voltage values, one or more target threshold current values, one or more target threshold frequency values, and/or one or more target threshold operating speed values, respectively.

An operating characteristic difference may include one or more determinations that an operating mode of the generator 140 and/or and operating mode of the power source 111 differs from a target operating mode of the generator 140 and/or a target operating mode of the power source 111, respectively. An operating characteristic difference may additionally and/or alternatively include one or more determinations that one or more magnitudes of a measured voltage, a measured current, a measured frequency, and/or a measured operating speed are higher than a target threshold voltage value, a target threshold current value, a target threshold frequency value, and/or a target threshold operating speed value, respectively. An operating characteristic difference may additionally and/or alternatively include one or more determinations that one or more magnitudes of a measured voltage, a measured current, a measured frequency, and/or a measured operating speed are lower than a target threshold voltage value, a target threshold current value, a target threshold frequency value, and/or a target threshold operating speed value, respectively. An operating characteristic difference may additionally and/or alternatively include one or more determinations that one or more magnitudes of a measured voltage, a measured current, a measured frequency, and/or a measured operating speed are outside of a target voltage value range, a target current value range, a target frequency value range, and/or a target operating speed value range, respectively.

In some examples, the control circuitry 150 continuously monitors one or more feedback signals and/or one or more measured operating characteristics. While monitoring one or more feedback signals and/or one or more measured operating characteristics, the control circuitry 150 may determine that there is not an operating characteristic difference (e.g., that a measured voltage value of 24.2 V is within a target voltage value range of 23.5-24.5 V). However, while monitoring one or more feedback signals and/or one or more measured operating characteristics, the control circuitry 150 may determine one or more operating characteristic differences (e.g., that a measured voltage value of 24.7 V is outside of a target voltage value range of 23.5-24.5 V and/or 0.2 V greater than an upper target threshold voltage value of 24.5 V).

In some examples, upon determining one or more operating characteristic differences, the control circuitry 150 outputs a control signal to control the power source 111 to modify an engine speed of an engine of the power source 111 based on the one or more operating characteristic differences. For example, the control circuitry 150 may increase or decrease an engine speed of the engine of the power source 111 based on one or more the one or more operating characteristic differences determined by the control circuitry 150. In some examples, the control circuitry 150 may control the engine of the power source 111 directly and/or indirectly (e.g., by outputting a control signal comprising an instruction to modify the engine speed to the PSCU 112). The control circuitry 150 may output a control signal via the one or more transceivers 152, the one or more interfaces 153, and/or one or more other devices, processes, and/or mechanisms.

In some examples, upon determining one or more operating characteristic differences, the control circuitry 150 outputs a control signal to control the power source 111 to modify a motor speed of a motor (e.g., an electric motor) of the power source 111 based on the one or more operating characteristic differences. For example, the control circuitry 150 may increase or decrease a motor speed of the motor of the power source 111 based on one or more the one or more operating characteristic differences determined by the control circuitry 150. In some examples, the control circuitry 150 may control the motor of the power source 111 directly and/or indirectly (e.g., by outputting a control signal comprising an instruction to modify the motor speed to the PSCU 112).

As an example, an electrical feedback loop of the one or more generator sensors 163C may measure a frequency of the electrical output of the generator 140 and generate a feedback signal comprising a measured frequency of 66 Hz. In the same example, the electrical feedback loop of the one or more generator sensors 163C may transmit the feedback signal to the control circuitry 150, e.g., via a wireless electrical coupling, via a wired electrical coupling, and/or by being an electrical feedback loop of the control circuitry 150. Upon receiving the measured frequency in the feedback signal, the control circuitry 150 compares the measured frequency to a target frequency (e.g., a target frequency value, one or more target threshold frequency values, and/or a target frequency value range). In this example, the control circuitry 150 may determine an operating characteristic difference including, e.g., any, some, or all of a difference between a magnitude of the measured frequency and either or both of a target frequency value and/or one or more target threshold frequency values, a determination that the magnitude of the measured frequency is less than a lower target threshold frequency value, a determination that the magnitude of the measured frequency is greater than an upper target threshold frequency value, and/or a determination that the magnitude of the measured frequency is outside a target frequency value range. For example, upon determining a target operating characteristic difference including a determination that the measured frequency of 66 Hz is both outside of a target frequency value range of 50-60 Hz of the target frequency and 6 Hz greater than an upper target threshold frequency value of 66 Hz of the target frequency, the control circuitry 150 may output the control signal to control the power source 111 to, e.g., reduce an engine speed of an engine of the power source 111 and/or reduce a motor speed of a motor (e.g., an electric motor) of the power source 111.

In some examples, the control circuitry 150 may monitor one measured operating characteristic or any plurality of measured operating characteristics (e.g., two measured operating characteristics, three measured operating characteristics, or even four or more measured operating characteristics), determine one operating characteristic difference or any plurality of operating characteristic differences (e.g., two operating characteristic differences, three operating characteristic differences, or even four or more operating characteristic differences), and/or modify an engine speed and/or a motor speed of an engine and/or a motor of the power source 111 based on determine one operating characteristic difference or any plurality of operating characteristic differences (e.g., two operating characteristic differences, three operating characteristic differences, or even four or more operating characteristic differences). For example, the one or more generator sensors 163C may measure a voltage of the electrical output of the generator 140 and generate a first feedback signal comprising a measured voltage while additionally measuring an operating speed of the generator 140 and further generating a second feedback signal comprising a measured operating speed. In this example, the control circuitry 150 may determine either or both of a first operating characteristic difference based on the measured voltage and a target voltage and/or a second operating characteristic difference based on the measured operating speed and a target operating speed. Upon determining either or both of the first and/or second operating characteristic differences, the control circuitry 150 may output the control signal to control the power source 111 to modify an engine speed and/or a motor speed of an engine and/or an electric motor of the power source 111 based on the first operating characteristic difference, the second operating characteristic difference, or both the first and second operating characteristic differences.

In some examples, the generator 140 may be configured to operate in one or more operating modes. In examples, an operating mode of a generator is an operational state of a generator defined by one or more predetermined parameters and/or one or more control processes. For example, a particular operating mode of the generator 140 may be a mode in which circuitry of the generator 140 is being controlled to generate and/or is otherwise generating a power output according to one or more predetermined operating characteristics and/or predetermined operating characteristic ranges. In some examples, an operating mode of the generator 140 is a function of an operating speed of the generator 140 and/or a function of an operating frequency of an electrical output of the generator 140 and/or the power conversion circuitry 141. In some examples, an operating mode of a generator may be one of a plurality of operational states in which the generator may operate. For example, the generator 140 may be configured to operate in and/or transition to and/or from an on mode, an off mode, an active mode, a standby mode, a synchronized speed mode, a variable speed mode, a fixed speed mode, and/or one or more other modes. In examples, one or more operating modes of a generator may be one or more subsets of one or more other operating modes of the generator.

In some examples, the power source 111 may be configured to operate in one or more operating modes. In examples, an operating mode of a power source (e.g., an engine, a motor, etc.) is an operational state of the power source defined by one or more predetermined parameters and/or one or more control processes. For example, a particular operating mode of the power source 111 may be a mode in which the power source 111 is being controlled to generate or is otherwise generating one or more predetermined operating characteristics and/or predetermined operating characteristic ranges. In some examples, an operating mode of the power source 111 is a function of an engine speed of an engine of the power source 111, a function of a motor speed of a motor (e.g., an electric motor) of the power source 111, and/or a function of a torque generated by the power source 111. In some examples, an operating mode of a power source may be one of a plurality of operational states in which the power source may operate. For example, the power source 111 may be configured to and/or controlled to operate in and/or transition to and/or from an on mode, an off mode, an active mode, a standby mode, a synchronized speed mode, a variable speed mode, a fixed speed mode, and/or one or more other modes. In examples, one or more operating modes of a power source may be one or more subsets of one or more other operating modes of the power source.

In some examples, the measured operating characteristic includes an ongoing operating mode of the power source 111 (i.e., an operating mode that the power source 111 is operating in at a time associated with the measured operating characteristic) and/or an ongoing operating mode of the generator 140 (i.e., an operating mode that the generator 140 is operating in at a time associated with the measured operating characteristic). In some examples, the control circuitry 150 may determine an operating mode of the power source 111 and/or an operating mode of the generator 140 based on one or more other measured operating characteristics and/or one or more target operating characteristics. For example, by comparing a plurality of measured voltages collected over a period of time to a target voltage associated with the same period of time, the control circuitry 150 may determine an operating state of the power source 111 and/or the generator 140. If the target operating mode includes an operating mode indication of the power source 111 (e.g., a synchronized speed mode indication for the power source 111) different than an ongoing operating mode of the power source 111 (e.g., a fixed speed mode of the power source 111), the control circuitry 150 may output the control signal to control the power source 111 to modify an engine speed and/or a motor speed of an engine and/or a motor (e.g., an electric motor) of the power source 111 such that the engine speed and/or the motor speed is controlled according to the operating mode of the operating mode indication (i.e., such that the power source 111 transitions to and/or beings operating in the synchronized speed mode). If the target operating mode includes an operating mode indication of the generator 140 (e.g., a standby mode indication for the generator 140) different than an ongoing operating mode of the generator 140 (e.g., a variable speed mode of the generator 140), the control circuitry 150 may output the control signal to control the power source 111 to modify an engine speed and/or a motor speed of an engine and/or a motor (e.g., an electric motor) of the power source 111 such that the generator 140 begins operating according to the operating mode of the operating mode indication (i.e., such that the generator 140 is transitioned to or made to begin operating in the variable speed mode).

In some examples, an on mode of the generator 140 is an operating mode in which circuitry of the generator 140 is being controlled to generate and/or is otherwise generating any power output and/or a power output greater than or equal to a predetermined threshold and/or within a predetermined range. In some examples, an on mode of the generator 140 may include one or more other operating modes (e.g., an active mode, a standby mode, a synchronized speed mode, a variable speed mode, a fixed speed mode, and/or one or more other modes). In some examples, an on mode of the generator 140 is a mode in which electrical power output by the generator 140 and/or the power conversion circuitry 141 has an operating frequency of greater than 0 Hz, greater than or equal to 5 Hz, greater than or equal to 10 Hz, greater than or equal to 20 Hz, or even greater than or equal to 35 Hz.

In some examples, an off mode of the generator 140 is an operating mode in which circuitry of the generator 140 is being controlled to not generate and/or is otherwise not generating any power output and/or a power output less than or equal to a predetermined threshold and/or within a predetermined range. In some examples, an off mode of the generator 140 is a mode in which electrical output of the generator 140 and/or the power conversion circuitry 141 has an operating frequency of 0 Hz, less than or equal to 5 Hz, less than or equal to 10 Hz, less than or equal to 20 Hz, or even less than or equal to 35 Hz.

In some examples, an active mode of the generator 140 is an operating mode in which circuitry of the generator 140 is outputting any electrical power and/or electrical power greater than or equal to a predetermined threshold value and/or within a predetermined range to (e.g., directly and/or via the power conversion circuitry 141) one or more components, systems, and/or devices (e.g., the one or more tools 142 and/or the one or more third auxiliary devices 144) while at least one of the one or more components, systems, and/or devices is exerting a load demand (e.g., measured in volts, amps, watts, kilogram-meters (“kg m”), kilogram-meters per second (“kg m/s”), RPM, etc.) upon the generator 140 (e.g., directly and/or via one or more of the power conversion circuitry 141, the one or more tools 142, and/or the one or more third auxiliary devices 144). In some examples, an active mode of the generator 140 is a mode in which an electrical output of the generator 140 and/or the power conversion circuitry 141 has an operating frequency greater than or equal to 45 Hz or greater than or equal to 55 Hz.

In some examples, a standby mode of the generator 140 is an operating mode in which circuitry of the generator 140 is outputting electrical power to (e.g., directly and/or via the power conversion circuitry 141) one or more components, systems, and/or devices (e.g., the one or more tools 142 and/or the one or more third auxiliary devices 144) while the one or more components, systems, and/or devices are exerting (e.g., directly and/or via the power conversion circuitry 141) no load demand upon the generator 140 and/or one or more load demands less than or equal to a predetermined threshold value and/or within a predetermined range. In examples, when in a standby mode, the generator 140 is operable to transition to one or more other operating modes (e.g., a synchronized speed mode, a variable speed mode, and/or a fixed speed mode) upon and/or during a triggering event (e.g., upon or while receiving a control signal). In some examples, after transitioning from the standby mode to another operating mode, upon another triggering event (e.g., cessation of the control signal, a predetermined time elapse, etc.), the generator 140 may be programmed and/or controlled to return to the standby mode. In some examples, a standby mode of the generator 140 is a mode in which an electrical output of the generator 140 and/or the power conversion circuitry 141 has an operating frequency less than or equal to 55 Hz or less than or equal to 45 Hz.

In some examples, a synchronized speed mode of the generator 140 is an operating mode in which an operating speed and/or a target operating speed of the generator 140 is controlled to be synchronized with one or more target operating characteristics (e.g., one or more target values, one or more threshold values, and/or one or more target value ranges) of an electrical output of the generator 140. For example, when operating in a synchronized speed mode, an operating speed of the generator 140 may be directly and/or indirectly modified based on differences between a measured operating characteristic (e.g., a measured voltage value of the electrical output of 23 V) and a target operating characteristic (e.g., a target voltage value of the electrical output of 24 V).

The term “directly controlled,” as used herein to describe control of an operating speed of a generator, includes modifying the operating speed of the generator by controlling a component, device, and/or system which determines and/or influences a magnitude of an input power provided to the generator. For example, “directly controlling” the operating speed of the generator 140 includes controlling the hydraulic motor 122, the third linkage 131, and/or the fourth linkage 132 to adjust a magnitude of a motor power provided to the generator 140.

The term “indirectly controlled,” as used herein to describe control of an operating speed of a generator, includes modifying the operating speed of the generator by controlling a component, device, and/or system which determines and/or influences a magnitude of a power provided to a component, device, and/or system that generates an input power provided to the generator. For example, “indirectly controlling” the operating speed of the generator 140 may include controlling an engine speed and/or a motor speed of an engine and/or a motor (e.g., an electric motor) of the power source 111 to adjust a flow rate of the input hydraulic flow generated by the hydraulic pump 121 and, thereby, adjust a magnitude of a flow rate of a motor power generated by the hydraulic motor 122 and provided to the generator 140.

In some examples, a variable speed mode of the generator 140 is an operating mode in which an operating speed and/or a target operating speed of the generator 140 is controlled to be synchronized with one or more target load demand (e.g., one or more target values, one or more threshold values, and/or one or more target value ranges) exerted upon the generator 140 (e.g., directly and/or via one or more of the power conversion circuitry 141, the one or more tools 142, and/or the one or more third auxiliary devices 144). For example, when operating in a variable speed mode, an operating speed of the generator 140 may be directly and/or indirectly modified based on differences between a measured load demand (e.g., a measured force of 14 kg m being generated by an electrical lift of the one or more third auxiliary devices 144) and a target load demand (e.g., a target force of 16 kg m to be generated by the electrical lift) of one or more components, devices, and/or systems receiving the electrical output from the generator 140 (e.g., directly and/or via the power conversion circuitry 141).

In some examples, a fixed speed mode of the generator 140 is an operating mode in which an operating speed of the generator 140 is controlled to be synchronized with a target operating speed (e.g., one or more target values, one or more threshold values, and/or one or more target value ranges) of the generator 140. For example, when operating in a fixed speed mode, an operating speed of the generator 140 may be directly and/or indirectly modified based on differences between a measured operating speed of the generator 140 and a target operating speed of the generator 140.

In some examples, an on mode of the power source 111 is an operating mode in which the power source 111 is being controlled to generate or is otherwise generating any input power and/or an input power greater than a predetermined threshold (e.g., a predetermined engine speed, a predetermined motor speed, and/or a predetermined torque) and/or within a predetermined range. In some examples, an on mode of the power source 111 may include one or more other operating modes (e.g., an active mode, a standby mode, a synchronized speed mode, a variable speed mode, a fixed speed mode, and/or one or more other modes).

In some examples, an off mode of the power source 111 is an operating mode in which the power source 111 is being controlled to not generate and/or is otherwise not generating any input power and/or an input power less or equal to than a predetermined threshold value (e.g., a predetermined engine speed, a predetermined motor speed, and/or a predetermined torque) and/or within a predetermined range.

In some examples, a standby mode of the power source 111 is an operating mode in which the power source 111 is generating an input power greater than or equal to a predetermined threshold value and/or within a predetermined range while one or more components, systems, and/or devices receiving (e.g., directly and/or indirectly) the input power (e.g., the generator 140, the hydraulic pump 121, the hydraulic motor 122, the power conversion circuitry 141, the one or more tools 142, and/or any, some, or all of the auxiliary devices 124, 134, 144) are experiencing no load demand and/or one or more load demands less than or equal to a predetermined threshold value and/or within a predetermined range. In examples, when in a standby mode, the power source 111 is operable to transition to one or more other operating modes (e.g., a synchronized speed mode, a variable speed mode, and/or a fixed speed mode) upon and/or during a triggering event (e.g., upon or while receiving a control signal). In some examples, after transitioning from the standby mode to another operating mode, upon another triggering event (e.g., cessation of the control signal, a predetermined time elapse, etc.), the power source 111 may be programmed and/or controlled to return to the standby mode.

In some examples, a synchronized speed mode of the power source 111 is an operating mode in which an engine speed and/or a motor speed of an engine and/or a motor (e.g., an electric motor) of the power source 111 is controlled to be synchronized with one or more target operating characteristics (e.g., one or more target values, one or more threshold values, and/or one or more target value ranges) of the generator 140 based on one or more measured operating characteristics of the generator 140. In some examples, when in the synchronized speed mode, the power source 111 is controlled to maintain and/or transition an operating characteristic of the generator 140 at a target value, above a threshold value, below a threshold value, and/or within a target valuer range. In some examples, when in the synchronized speed mode, an engine speed and/or a motor speed of an engine and/or a motor (e.g., an electric motor) of the power source 111 is synchronized with any, some, or all of a target voltage of an electrical output of the generator 140, a target frequency of an electrical output of the generator 140, a target current of an electrical output of the generator 140, a target operating speed of the generator 140, and/or a target operating mode of the generator 140. In some examples, when in the synchronized speed mode, an engine speed and/or a motor speed of an engine and/or a motor (e.g., an electric motor) of the power source 111 is controlled based on one or more feedback signals comprising any, some, or all of a measured voltage of an electrical output of the generator 140, a measured frequency of an electrical output of the generator 140, a measured current of an electrical output of the generator 140, a measured operating speed of the generator 140, and/or an ongoing operating mode of the generator 140. For example, when operating in a synchronized speed mode, an engine speed and/or a motor speed of an engine and/or a motor (e.g., an electric motor) of the power source 111 may be modified based on differences between a measured operating characteristic of the generator 140 (e.g., a measured voltage value of the electrical output of 23 V) and a target operating characteristic of the generator 140 (e.g., a target voltage value of the electrical output of 24 V).

In some examples, a variable speed mode of the power source 111 is an operating mode in which an engine speed and/or a motor speed of an engine and/or a motor (e.g., an electric motor) of the power source 111 is controlled to be synchronized with one or more target load demands (e.g., one or more target values, one or more threshold values, and/or one or more target value ranges) exerted upon the generator 140 (e.g., directly and/or via one or more of the power conversion circuitry 141, the one or more tools 142, and/or the one or more third auxiliary devices 144). For example, when operating in a variable speed mode, an engine speed and/or a motor speed of an engine and/or a motor (e.g., an electric motor) of the power source 111 may be modified based on differences between a measured load demand (e.g., a measured force of 14 kg m being generated by an electrical lift of the one or more third auxiliary devices 144) and a target load demand (e.g., a target force of 16 kg m to be generated by the electrical lift) of one or more components, devices, and/or systems receiving the electrical output from the generator 140 (e.g., directly and/or via the power conversion circuitry 141).

In some examples, a fixed speed mode of the power source 111 is an operating mode in which an engine speed and/or a motor speed of an engine and/or a motor (e.g., an electric motor) of the power source 111 is controlled to be synchronized with a target speed (e.g., one or more target values, one or more threshold values, and/or one or more target value ranges) of the power source 111 (e.g., a target engine speed of an engine of the power source 111, a target motor speed of an electric motor of the power source 111, a target torque of the power source 111, etc.). For example, when operating in a fixed speed mode, an engine speed and/or a motor speed of an engine and/or a motor (e.g., an electric motor) of the power source 111 may be controlled to be at a target speed or within a target speed range.

In some examples, the control circuitry 150 may receive a measured load demand of one or more of the auxiliary devices 124, 134, 144 the one or more tools 142 in a feedback signal generated by one of the output equipment sensors 163D. In some such examples, may monitor the feedback signal and/or the measured load to determine a load difference based on a target load and the measured load. In some examples, the load difference may be determined similarly to an operating characteristic difference, as described elsewhere herein. In some examples, upon determining the load difference, the control circuitry 150 may output the control signal to control the power source 111 to modify an engine speed and/or a motor speed of an engine and/or a motor (e.g., an electric motor) of the power source 111 based on the load difference. In some examples, the control circuitry 150 may control the power source 111 to modify an engine speed and/or a motor speed of an engine and/or a motor (e.g., an electric motor) of the power source 111 based on the load difference in a similar manner to the controlling of the power source 111 to modify an engine speed and/or a motor speed of an engine and/or a motor (e.g., an electric motor) of the power source 111 based on an operating characteristic difference described elsewhere herein. In some examples, the control circuitry 150 may monitor one feedback signal or any plurality of feedback signals and/or one measured load or any plurality of measured loads, determine one load difference or any plurality of load differences based on one target load or any plurality of target loads, and/or control the power source 111 to modify an engine speed and/or a motor speed of an engine and/or a motor (e.g., an electric motor) of the power source 111 based on one load difference or any plurality of load differences. In some examples, the control circuitry 150 may monitor one or more measured loads and/or one or more measured operating characteristics, determine one or more load differences based on one or more target loads and/or determine one or more operating characteristic differences based on one or more target operating characteristics, and/or control the power source 111 to modify an engine speed and/or a motor speed of an engine and/or a motor (e.g., an electric motor) of the power source 111 based on one or more load differences and/or based on or more operating characteristic differences.

In some examples, the system 100 may include none, only one, or any plurality of the vehicle 110, the power source 111, the PSCU 112, the hydraulic circuit 120, the hydraulic pump 121, the hydraulic motor 122, the drive assembly 130, the generator 140, the power conversion circuitry 141, and/or the control circuitry 150.

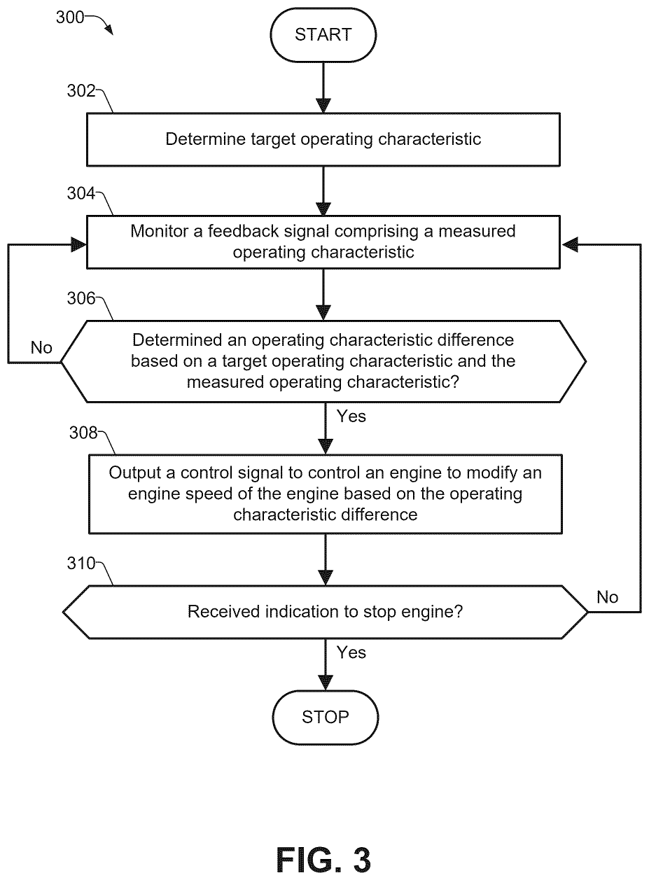

FIG. 3 is a flowchart illustrating an example of a first process 300 of operating a hydraulically powered power system (e.g., the system 100). The first process 300 may be implemented by control circuitry (e.g., the control circuitry 150 and/or the PSCU 112) by executing machine-readable instructions, e.g., stored on a non-transitory machine-readable storage device (e.g., the memory storage device 154). In describing the first process 300, reference will be made to the examples of FIGS. 1 and 2. However, the first process 300 may be used with other examples, such as alternative examples described elsewhere herein.

At a block 302 of the first process 300, the control circuitry 150 determines one or more target operating characteristics. Each of the one or more target operating characteristics may be associated with one or more operating characteristics of the generator 140. The control circuitry 150 may determine one or more target operating characteristics based on any, some, or all of one or more user interface signals generated by the user interface 164, one or more output equipment signals generated by the one or more tools 142 and/or any, some, or all of the auxiliary devices 124, 134, 144, one or more feedback signals generated by any, some, or all of the sensors 163A, 163B, 163C, 163D, and/or one or more other sensors, one or more predetermined target values, one or more predetermined target threshold values, one or more predetermined target value ranges, and/or one or more percentages. In some examples, the first process 300 does not include the block 302.

At a block 304 of the first process 300, the control circuitry 150 monitors a feedback signal comprising a measured operating characteristic associated with an operating characteristic of the generator 140. In some examples, the control circuitry 150 monitors a plurality of feedback signals. In some examples, the feedback signal comprises a plurality of measured operating characteristics. In some examples, the control circuitry 150 determines a measured operating characteristic based on the feedback signal. In some examples, the one or more generator sensors 163C generate the feedback signal. In some examples, any, some, or all of the sensors 163A, 163B, 163C, 163D generate the feedback signal.

At a block 306 of the first process 300, the control circuitry 150 determines one or more operating characteristic differences based on one or more target operating characteristics and one or more measured operating characteristics. In some examples, the control circuitry 150 does not determine a target operating characteristic in the block 306. In some such examples, the control circuitry 150 returns to the block 304. In some examples, the control circuitry 150 determines only one operating characteristic difference. In some examples, the control circuitry 150 determines any plurality of operating characteristic differences. In some examples, the control circuitry 150 determines only one operating characteristic difference based on only one target operating characteristic and only one measured operating characteristic. In some examples, the control circuitry 150 determines any plurality of operating characteristic differences based on only one target operating characteristic and only one measured operating characteristic. In some examples, the control circuitry 150 determines only one operating characteristic difference based on any plurality of target operating characteristics and only one measured operating characteristic. In some examples, the control circuitry 150 determines only one operating characteristic difference based on only one target operating characteristic and any plurality of measured operating characteristics. In some examples, the control circuitry 150 determines any plurality of operating characteristic differences based on any plurality of target operating characteristics and only one measured operating characteristic. In some examples, the control circuitry 150 determines any plurality of operating characteristic differences based on only one target operating characteristic and any plurality of measured operating characteristics. In some examples, the control circuitry 150 determines only one operating characteristic difference based on any plurality of target operating characteristics and any plurality of measured operating characteristics. In some examples, the control circuitry 150 determines any plurality of operating characteristic differences based on any plurality of target operating characteristics and any plurality of measured operating characteristics.

At a block 308 of the first process 300, the control circuitry 150 outputs a control signal to control an engine of the power source 111 to modify an engine speed of the engine of the power source 111 based on the one or more operating characteristic differences. In some examples, the control circuitry 150 controls the engine of the power source 111 directly. In some examples, the control circuitry 150 controls the engine of the power source 111 by outputting a control signal comprising an instruction to modify the engine speed of the engine of the power source 111 to the PSCU 112. In some examples, the control circuitry 150 controls the engine of the power source 111 to modify an engine speed of the engine of the power source 111 based on only one operating characteristic difference. In some examples, the control circuitry 150 controls the engine of the power source 111 to modify an engine speed of the engine of the power source 111 based on any plurality of operating characteristic differences. In some examples, the first process 300 ends after the block 308. In some examples, the first process 300 continuously reiterates the blocks 304, 306, 308 until a trigger event.

At a block 310 of the first process 300, the control circuitry 150 checks for receipt of an indication to stop the engine of the power source 111 and/or the first process 300. In some examples, the control circuitry 150 receives a user interface signal from the user interface 164 (generated by, e.g., a user using the user interface 164) indicating that the engine of the power source 111 should stop operating (e.g., enter an off state) and/or that the control circuitry 150 should cease conducting the first process 300. In some examples, the control circuitry 150 receives a signal from the one or more control systems 161, the one or more remote computers 162, and/or one or more other control circuitries indicating that the engine of the power source 111 should stop operating (e.g., enter an off state) and/or that the control circuitry 150 should cease conducting the first process 300. In some examples, the first process 300 does not include the block 310.

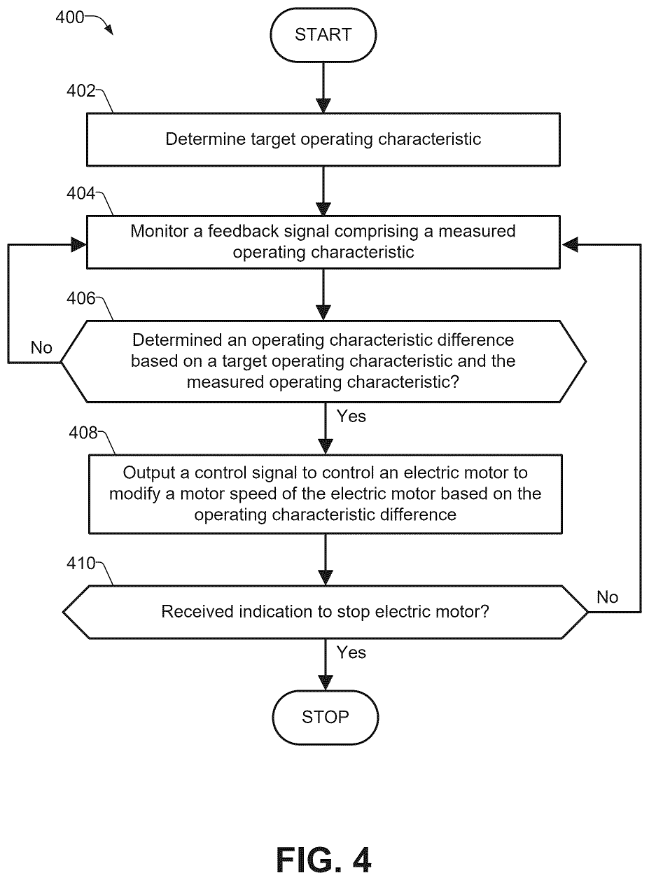

FIG. 4 is a flowchart illustrating an example of a second process 400 of operating a hydraulically powered power system (e.g., the system 100). The second process 400 may be implemented by control circuitry (e.g., the control circuitry 150 and/or the PSCU 112) by executing machine-readable instructions, e.g., stored on a non-transitory machine-readable storage device (e.g., the memory storage device 154). In describing the second process 400, reference will be made to the examples of FIGS. 1 and 2. However, the second process 400 may be used with other examples, such as alternative examples described elsewhere herein. In describing the second process 400, reference is made to an electric motor of the power source 111. However, the second process 400 may be used with one or more other types of motors of the power source 111.

At a block 402 of the second process 400, the control circuitry 150 determines one or more target operating characteristics. Each of the one or more target operating characteristics may be associated with one or more operating characteristics of the generator 140. The control circuitry 150 may determine one or more target operating characteristics based on any, some, or all of one or more user interface signals generated by the user interface 164, one or more output equipment signals generated by the one or more tools 142 and/or any, some, or all of the auxiliary devices 124, 134, 144, one or more feedback signals generated by any, some, or all of the sensors 163A, 163B, 163C, 163D, and/or one or more other sensors, one or more predetermined target values, one or more predetermined target threshold values, one or more predetermined target value ranges, and/or one or more percentages. In some examples, the second process 400 does not include the block 402.

At a block 404 of the second process 400, the control circuitry 150 monitors a feedback signal comprising a measured operating characteristic associated with an operating characteristic of the generator 140. In some examples, the control circuitry 150 monitors a plurality of feedback signals. In some examples, the feedback signal comprises a plurality of measured operating characteristics. In some examples, the control circuitry 150 determines a measured operating characteristic based on the feedback signal. In some examples, the one or more generator sensors 163C generate the feedback signal. In some examples, any, some, or all of the sensors 163A, 163B, 163C, 163D generate the feedback signal.

At a block 406 of the second process 400, the control circuitry 150 determines one or more operating characteristic differences based on one or more target operating characteristics and one or more measured operating characteristics. In some examples, the control circuitry 150 does not determine a target operating characteristic in the block 406. In some such examples, the control circuitry 150 returns to the block 404. In some examples, the control circuitry 150 determines only one operating characteristic difference. In some examples, the control circuitry 150 determines any plurality of operating characteristic differences. In some examples, the control circuitry 150 determines only one operating characteristic difference based on only one target operating characteristic and only one measured operating characteristic. In some examples, the control circuitry 150 determines any plurality of operating characteristic differences based on only one target operating characteristic and only one measured operating characteristic. In some examples, the control circuitry 150 determines only one operating characteristic difference based on any plurality of target operating characteristics and only one measured operating characteristic. In some examples, the control circuitry 150 determines only one operating characteristic difference based on only one target operating characteristic and any plurality of measured operating characteristics. In some examples, the control circuitry 150 determines any plurality of operating characteristic differences based on any plurality of target operating characteristics and only one measured operating characteristic. In some examples, the control circuitry 150 determines any plurality of operating characteristic differences based on only one target operating characteristic and any plurality of measured operating characteristics. In some examples, the control circuitry 150 determines only one operating characteristic difference based on any plurality of target operating characteristics and any plurality of measured operating characteristics. In some examples, the control circuitry 150 determines any plurality of operating characteristic differences based on any plurality of target operating characteristics and any plurality of measured operating characteristics.

At a block 408 of the second process 400, the control circuitry 150 outputs a control signal to control an electric motor of the power source 111 to modify a motor speed of the electric motor of the power source 111 based on the one or more operating characteristic differences. In some examples, the control circuitry 150 controls the electric motor of the power source 111 directly. In some examples, the control circuitry 150 controls the electric motor of the power source 111 by outputting a control signal comprising an instruction to modify the motor speed of the electric motor of the power source 111 to the PSCU 112. In some examples, the control circuitry 150 controls the electric motor of the power source 111 to modify a motor speed of the electric motor of the power source 111 based on only one operating characteristic difference. In some examples, the control circuitry 150 controls the electric motor of the power source 111 to modify a motor speed of the electric motor of the power source 111 based on any plurality of operating characteristic differences. In some examples, the second process 400 ends after the block 408. In some examples, the second process 400 continuously reiterates the blocks 404, 406, 408 until a trigger event.

At a block 410 of the second process 400, the control circuitry 150 checks for receipt of an indication to stop the electric motor of the power source 111 and/or the second process 400. In some examples, the control circuitry 150 receives a user interface signal from the user interface 164 (generated by, e.g., a user using the user interface 164) indicating that the electric motor of the power source 111 should stop operating (e.g., enter an off state) and/or that the control circuitry 150 should cease conducting the second process 400. In some examples, the control circuitry 150 receives a signal from the one or more control systems 161, the one or more remote computers 162, and/or one or more other control circuitries indicating that the electric motor of the power source 111 should stop operating (e.g., enter an off state) and/or that the control circuitry 150 should cease conducting the second process 400. In some examples, the second process 400 does not include the block 410.

While the present method, apparatus, and/or system has been described with reference to certain implementations, it will be understood by those skilled in the art that various changes, modifications, and variations may be made to the present disclosure and equivalents may be substituted without departing from the scope of the present disclosure. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A hydraulically powered power system comprising:
a hydraulic motor configured to convert an input hydraulic flow to motor power;
a generator drivingly coupled to the hydraulic motor and configured to convert the motor power to an electrical output;
a first sensor configured to measure a first operating characteristic of the generator and to generate a first feedback signal comprising a first measured operating characteristic associated with the first operating characteristic; and
control circuitry configured to:
monitor the first feedback signal to determine a first operating characteristic difference based on a first target operating characteristic and the first measured operating characteristic, and
upon determining the first operating characteristic difference, output a control signal to control an engine to modify an engine speed of the engine based on the first operating characteristic difference.

2. The hydraulically powered power system of claim 1, wherein the first operating characteristic comprises at least one of:
a voltage of the electrical output;
a frequency of the electrical output; or
a current of the electrical output.

3. The hydraulically powered power system of claim 1, wherein the first operating characteristic comprises an operating speed of the generator.

4. The hydraulically powered power system of claim 1, wherein the first operating characteristic comprises an operating mode of the generator.

5. The hydraulically powered power system of claim 1, wherein the first target operating characteristic comprises at least one of:
a target voltage of the electrical output;
a target frequency of the electrical output; or
a target current of the electrical output.

6. The hydraulically powered power system of claim 1, wherein the first target operating characteristic comprises a target operating speed of the generator.

7. The hydraulically powered power system of claim 1, wherein the first target operating characteristic comprises a target operating mode of the generator.

8. The hydraulically powered power system of claim 7, wherein the control circuitry is further configured to, upon determining that the target operating mode comprises a standby mode indication and that the first operating characteristic difference comprises a difference in operating mode, output the control signal to control the engine to operate at a standby speed.

9. The hydraulically powered power system of claim 7, wherein the control circuitry is further configured to, upon determining that the target operating mode comprises a synchronized speed mode indication and that the first operating characteristic difference comprises a difference in operating mode of the generator, output the control signal to control the engine to operate at a synchronized engine speed based on a target value of the first target operating characteristic.

10. The hydraulically powered power system of claim 7, wherein the control circuitry is further configured to, upon determining that the target operating mode comprises a variable mode indication and that the first operating characteristic difference comprises a difference in operating mode of the generator, output the control signal to control the engine to operate at a variable engine speed based on a variable target value of the first target operating characteristic.

11. The hydraulically powered power system of claim 7, wherein the control circuitry is further configured to, upon determining that the target operating mode comprises a fixed speed mode indication and that the first operating characteristic difference comprises a difference in operating mode of the generator, output the control signal to control the engine to operate at a fixed engine speed based on a target value of the first target operating characteristic.

12. The hydraulically powered power system of claim 1, wherein:
the first target operating characteristic comprises a target value; and
the control circuitry is further configured to determine the first operating characteristic difference by determining a difference between a magnitude of the first measured operating characteristic and the target value.

13. The hydraulically powered power system of claim 1, wherein:
the first target operating characteristic comprises a target threshold value; and
the control circuitry is further configured to determine the first operating characteristic by determining that a magnitude of the first measured operating characteristic is higher than or lower than the target threshold value.

14. The hydraulically powered power system of claim 1, wherein:
the first target operating characteristic comprises a target value range; and
the control circuitry is further configured to determine the first operating characteristic difference by determining that a magnitude of the first measured operating characteristic is outside of the target value range.

15. The hydraulically powered power system of claim 1, further comprising a user interface configured to generate a user interface signal, wherein the control circuitry is further configured to determine the first target operating characteristic based on the user interface signal.

16. The hydraulically powered power system of claim 1, further comprising output equipment configured to receive the electrical output from the generator and generate an output equipment signal, wherein the control circuitry is further configured to determine the first target operating characteristic based on the output equipment signal.

17. The hydraulically powered power system of claim 1, further comprising a second sensor configured to generate a second feedback signal, wherein the control circuitry is further configured to determine the first target operating characteristic based on the second feedback signal.

18. The hydraulically powered power system of claim 1, wherein the first target operating characteristic comprises at least one of a predetermined target value, one or more predetermined target threshold values, or a predetermined target value range.

19. The hydraulically powered power system of claim 1, further comprising a hydraulic pump configured to receive input power from the engine and to convert the input power to the input hydraulic flow, wherein the hydraulic motor is hydraulically coupled to the hydraulic motor.

20. The hydraulically powered power system of claim 1, further comprising:
output equipment configured to receive the electrical output from the generator; and
a second sensor configured to measure a load of the output equipment and to generate a second feedback signal comprising a measured load associated with the load, wherein the control circuitry is further configured to:
monitor the second feedback signal to determine a load difference based on a target load and the measured load, and
upon determining the load difference, output the control signal to control the engine to modify the engine speed based on the load difference.
